(19) United States
(12) Patent Application Publication
(10) Pub. No.: US 2023/0092952 A1
(43) Pub. Date: Mar. 23, 2023

(54) POLYUREA COPOLYMER

(71) Applicant: BASF SE, Ludwigshafen am Rhein (DE)

(72) Inventors: Sandra Gloria KOENIG, Ludwigshafen am Rhein (DE); Susanne Carina ENGERT, Ludwigshafen am Rhein (DE); Aggeliki QUELL, Ludwigshafen am Rhein (DE); Alexander Michael HAYDL, Ludwigshafen am Rhein (DE); Michael ZEILINGER, Ludwigshafen am Rhein (DE); Dag WIEBELHAUS, Ludwigshafen am Rhein (DE)

(21) Appl. No.: 17/784,132

(22) PCT Filed: Dec. 14, 2020
(86) PCT No.: PCT/EP2020/086033

§ 371 Date: Jun. 10, 2022

(30) Foreign Application Priority Data
Dec. 17, 2019 (EP) 19216776.5

(51) Int. Cl. C08G 18/08; C08G 18/50; C08L 75/02

(52) U.S. Cl. CPC C08G 18/0852; C08G 18/5024; C08L 75/02

(57) ABSTRACT

The presently claimed invention is directed to a polyurea-polyetheramine copolymer obtained by reacting at least one polyisocyanate (A) and at least one isocyanate reactive component (B); wherein the at least one polyisocyanate (A) has an NCO functionality of at least ≥2.0; and the at least one isocyanate reactive component (B) is a polyetheramine having at least two secondary amine functional groups and at least one hydroxy functional group.

### FIELD OF INVENTION

The presently claimed invention is directed to a polyurea-polyetheramine copolymer which is obtained by reacting at least one polyisocyanate (A) and at least one isocyanate reactive component (B); wherein the at least one polyisocyanate (A) has an NCO functionality of at least ≥2.0; and the at least one isocyanate reactive component (B) is a polyetheramine having at least two secondary amine functional groups and at least one hydroxy functional group.

### BACKGROUND OF INVENTION

There is a need in the material and polymer sciences to develop polymeric materials with desired in-use performance characteristics that are also malleable, repairable, and shape reprogrammable. There is also a need to develop such polymers that can be degraded or reversibly depolymerized. Even though shape memory and self-healing polymers are known, many of these polymers do not have both the desired performance and dynamic characteristics. For example, many shape memory polymers, which depend on the formation of covalent crosslinks, cannot be processed, reprogrammed, or recycled after the permanent shape is set by covalent crosslinking. With respect to degradable or reversibly depolymerizable polymers, these polymers often lack the required in-use performance characteristics and are either too easily degraded or on the other hand not degraded as readily or rapidly as desired.

Differing from polymers formed with strong, irreversible covalent bonds and stable bulk properties, polymers prepared through reversible non-covalent interactions or covalent bonds exhibit various dynamic properties. The dynamic features of reversible polymers have been employed in the design of self-healing, shape-memory, and environmentally adaptive materials. However, non-covalent interactions are relatively weak, with only a few exceptions such as quadruple hydrogen bonding, high valence metal chelation, and host-guest molecular interactions. Dynamic covalent bonds, on the contrary, usually have higher strength and more controllable reversibility.

Introducing bulky substituents has been theorized to create steric hindrance to disturb the orbital co-planarity of the amide bond, which diminishes the conjugation effect and thus weakens the carbonyl-amine interaction. However, the dissociated intermediate from amidolysis, would be a ketene, and if formed would generally be too reactive to provide dynamic reversible formation of the amide bond. To make the carbonyl-amine structure reversible, it is required that the dissociated carbonyl structure be stable under ambient conditions, but still highly reactive with amines. One such functional group that satisfies these requirements is the isocyanate group, which can be used to form urea linkages. Isocyanates are generally sufficiently stable under ambient conditions and can react with amines rapidly to form a urea bond, a reaction that has been broadly used in the synthesis of polyurea and poly(urethane-urea). Therefore, it would be highly desirable to control the reversibility and the kinetics of these urea bonds in polymeric materials.

Polymers can be formed from the reaction of one or more isocyanates with one or more amines. These polymers can be formed by bringing the isocyanates in contact with the amines using static mixing equipment, high-pressure impingement mixing equipment, low-pressure mixing equipment, roller with mixing attachments and simple hand mixing techniques. These polymers are useful in caulks, adhesives, sealants, coatings, foams, and many other applications. Specific examples include, but are not limited to, truck-bed liners, concrete coatings, and molded articles.

US 2007/0208156 A1 discloses polyurea, polyurethane, and polyurea-polyurethane hybrid, made from an isocyanate, a secondary polyetheramine, a second amine, and optionally a polyol. The secondary polyetheramine may be used in combination with the second amine to modify other properties of the polymer, including its cure time and cost. The secondary polyetheramine comprises secondary polyoxyalkylene amines.

US 2016/0030254 A1 discloses a reversible polymer that is formed from polyurea by modifying the nitrogen atom with hindered substituents. The reversibility of the hindered urea bond is controlled by changing the bulkiness of the substituents. The selection of hindered urea polymer with its high binding constant and short lifetime makes it possible to design the reversible and the self-healing polymeric materials at mild temperatures without an external stimulus.

US 2017/327627 A1 discloses malleable, repairable, and reprogrammable shape memory polymers having hindered urea bonds.

The above prior arts describe the formation of linear polyurea polymers.

It is an object of the presently claimed invention to provide a polyurea polymer having three-dimensional network structure.

Another object of the invention is to provide a recyclable three-dimensional network polyurea copolymer.

### SUMMARY OF INVENTION

The object is achieved by reacting at least one polyisocyanate (A) and at least one isocyanate reactive component (B); wherein the at least one polyisocyanate (A) has an NCO functionality of at least ≥2.0; and the at least one isocyanate reactive component (B) is a polyetheramine having at least two secondary amine functional groups and at least one hydroxy functional group.

Accordingly, in a first aspect, the presently claimed invention is directed to a polyurea copolymer obtained by reacting:
a. at least one polyisocyanate (A); and
b. at least one isocyanate reactive component (B);
   wherein the at least one polyisocyanate (A) has an NCO functionality of at least ≥2.0; and the at least one isocyanate reactive component (B) is selected from the group consisting of a compound of formula (B1), formula (B2), r a formula (B3) and a formula (B4),

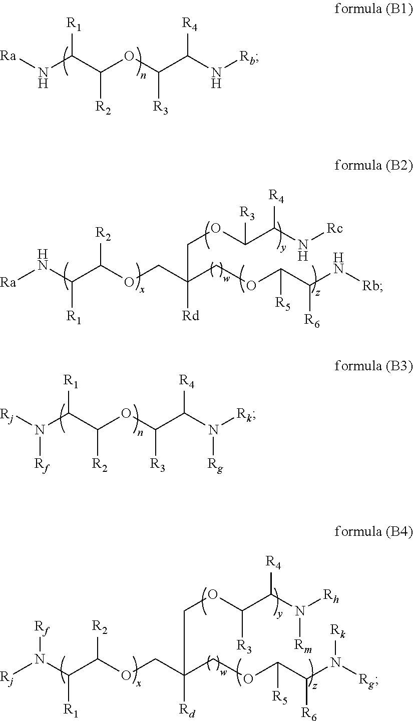

wherein

Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 1000;

w is an integer in the range of 0 to 30;

t, x, y and z are independent of each and an integer in the range of 0 to 1000, with the provision that the sum of t+x+y+z is in the range of 1 to 3000.

In a second aspect, the presently claimed invention is directed to a process for preparing a polyurea copolymer as described herein comprising at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is a polyetheramine having at least two secondary amine functional groups and at least one hydroxy functional group.

In a third aspect, the presently claimed invention is directed to an article comprising a polyurea copolymer as described herein.

In fourth aspect, the presently claimed invention is directed to a process for reshaping a polyurea copolymer comprising at least the steps of:
a) applying pressure and heat to the polyurea copolymer as described herein to obtain a heated polyurea copolymer; and
b) reshaping the polyurea copolymer of step a).

### DETAILED DECEPTION OF INVENTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

In a first embodiment, the presently claimed invention is directed to a polyurea copolymer obtained by reacting:
a. at least one polyisocyanate (A); and
b. at least one isocyanate reactive component (B);
   wherein the at least one polyisocyanate (A) has an NCO functionality of at least ≥2.0; and the at least one isocyanate reactive component (B) is)selected from the group consisting of a compound of formula (B1), formula (B2), a formula (B3) and a formula (B4),

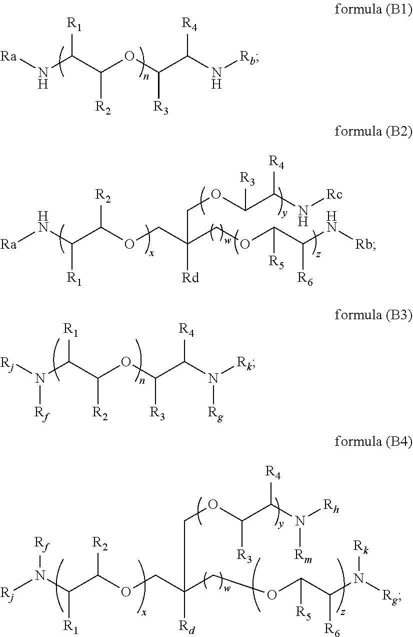

wherein

Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 1000;

w is an integer in the range of 0 to 30;

t, x, y and z are independent of each and an integer in the range of 0 to 1000, with the provision that the sum of t+x+y+z is in the range of 1 to 3000;

more preferably the polyurea copolymer is obtained by reacting:
a. at least one polyisocyanate (A); and
b. at least one isocyanate reactive component (B);
   wherein the at least one polyisocyanate (A) has an NCO functionality of at least ≥2.0; and the at least one isocyanate reactive component (B) is selected from the group consisting of a compound of formula (B1), formula (B2), a formula (B3) and a formula (B4),

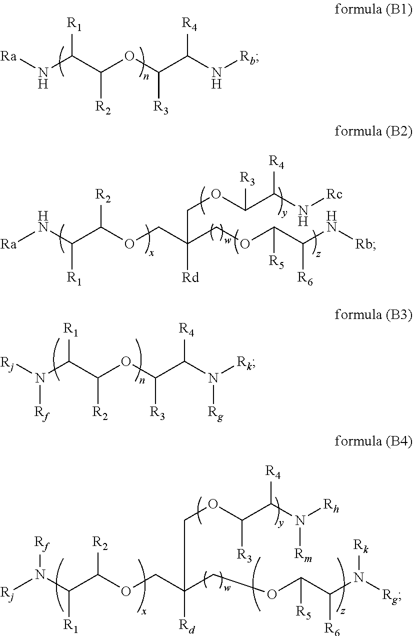

wherein

Rₐ, R_{b}, R_{c}, R_{g}, Rₘ and Rₑ independently of each other are selected from the group consisting of linear or branched, substituted or unsubstituted C₁-C₃₀ alklyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 1000;

w is an integer in the range of 0 to 30;

t, x, y and z are independent of each and an integer in the range of 0 to 1000, with the provision that the sum of t+x+y+z is in the range of 1 to 3000.

In another preferred embodiment, the at least one polyisocyanate (A) has an average NCO functionality in the range of ≥2.0 to ≤6.0; more preferably the at least one polyisocyanate (A) has an average NCO functionality in the range of ≥2.0 to ≤5.0; even more preferably the at least one polyisocyanate (A) has an average NCO functionality in the range of ≥2.0 to ≤4.0; most preferably the at least one polyisocyanate (A) has an average NCO functionality in the range of ≥2.0 to ≤3.5; and in particular the at least one polyisocyanate (A) has an average NCO functionality in the range of ≥2.0 to ≤3.0.

In another preferred embodiment, the at least one polyisocyanate (A) is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene -1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene -1,6-diisocyanate, nonamethylene diisocyanate, 2,2,4-trimethylhexamethylene -1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(para-isocyano -cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato -cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy -biphenylene diisocyanate, 2,4-bis(b-isocyanato-t-butyl)toluene, bis(para-b-isocyanato-t-butyl -phenyl)ether, para-bis(2-methyl-4-isocyanatophenyl)benzene, 3,3-diisocyanato adamantane, 3,3-diisocyano biadamantane, 3,3-diiso-cyanatoethyl-1-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester l-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene)isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4 ,4′-triisocyanato-dicyclohexylmethane, triisocyanate triphenylthiophosphate, 2,4,4′-diphenylether triisocyanate and polymeric form of diisocyanates and triisocyanates; more preferably the at least one polyisocyanate (A) is selected from the group consisting of isophorone diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, 2,2,4-trimethylhexamethylene-1,6-diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2′-oxydiphenyl diisocyanate, 3,3′-oxydiphenyl diisocyanate, 4,4′-oxydiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene -bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(para-isocyano-cyclohexyl)sulfide, bis(para-isocyanato-cyclohexyl)sulfone, bis(para-isocyano-cyclohexyl)ether, 3,3′-dimethyl-4,4′-diisocyano biphenyl, 3,3′-dimethoxy-biphenylene diisocyanate, 2,4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diisocyanatoethyl-1′-biadamantane, 1,2-bis (3-isocyanato-propoxy)ethane, 1,4-diisocyanato cyclohexane, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester l-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene)isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4 ,4′-triisocyanato-dicyclohexylmethane, triisocyanate triphenylthiophosphate, 2,4,4′-diphenylether triisocyanate and polymeric form of diisocyanates and triisocyanates; even more preferably the at least one polyisocyanate (A) is selected from the group consisting of isophorone diisocyanate, hexamethylene-1,6-diisocyanate, 1,5-pentamethylene diisocyanate, octamethlyene-1,8-diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2′-oxydiphenyl diisocyanate, 3,3′-oxydiphenyl diisocyanate, 4,4′-oxydiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), bis(para-isocyano-cyclohexyl)ether, 1,4-diisocyanato cyclohexane, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester l-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates; most preferably the at least one polyisocyanate (A) is selected from the group consisting of isophorone diisocyanate, hexamethylene-1,6-diisocyanate, 1,5-pentamethylene diisocyanate, octamethlyene-1,8-diisocyanate, toluene-2,4-diisocyanate, toluene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene -bis(cyclohexyl isocyanate), bis(para-isocyano-cyclohexyl)ether, 1,4-diisocyanato cyclohexane, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester l-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene)isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates; and in particular the at least one polyisocyanate (A) is selected from the group consisting of isophorone diisocyanate, hexamethylene-1,6-diisocyanate, 1,5-pentamethylene diisocyanate, octamethlyene-1,8-diisocyanate, toluene-2,4-diisocyanate, toluene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2,-methylene-bis(cyclohexyl isocyanate), 3,3′-methylene -bis(cyclohexyl isocyanate), 4,4′-methylene-bis(cyclohexyl isocyanate), 1,4-diisocyanato cyclohexane, triphenylmethane-4,4′,4″-triisocyanate, toluene-2,4,6-triyl triisocyanate, (2,4,6-trioxotriazine-1,3,5(2h,4h,6h)-triyl)tris(hexamethylene) isocyanate, 1,3,5-triisocyanatobenzene, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates.

In another preferred embodiment, the at least one polyisocyanate (A) is selected from the group consisting of isophorone diisocyanate, hexamethylene-1,6-diisocyanate, 1,5-pentamethylene diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-bi phenylene diisocyanate, 3,3′-bi phenylene diisocyanate, 4,4′-biphenylene diisocyanate, 3,3′-dimethyl-4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates.

In another preferred embodiment, the polymeric form of diisocyanates and triisocyanates denotes isocyanates that exist as a dimeric, trimeric and oligomeric structure.

In another preferred embodiment, the at least one polyisocyanate (A) is present in the form of dimers, trimers and oligomers containing a urethane group, an isocyanurate group, a biuret group, an uretdione group, an allophanate group and/or an iminooxadiazinedione group.

In another preferred embodiment, the at least one isocyanate reactive component (B) is selected from the group consisting of a compound of formula (B1), formula (B2), a formula (B3) and a formula (B4),

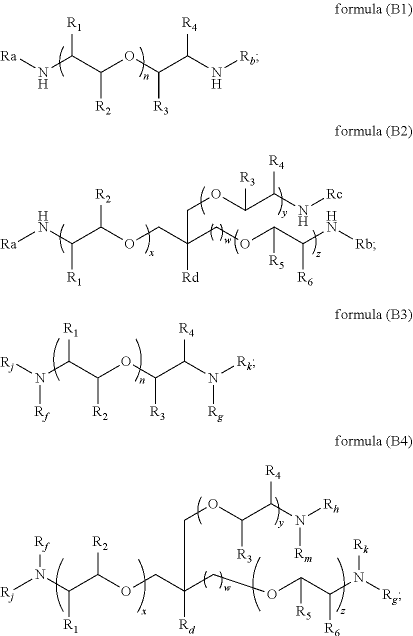

wherein

Rₐ, R_{b}, R_{c}, R_{g}, Rₘ and Rₑ independently of each other are selected from the group consisting of linear or branched, substituted or unsubstituted C₁-C₃₀ alklyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 1000;

w is an integer in the range of 0 to 30;

t, x, y and z are independent of each and an integer in the range of 0 to 1000, with the provision that the sum of t+x+y+z is in the range of 1 to 3000;

more preferably Rₐ, R_{b}, Rₑ, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, and propyl;

n is an integer in the range of 1 to 500;

w is an integer in the range of 0 to 10;

t, x, y and z are independent of each and an integer in the range of 0 to 500, with the provision that the sum of t+x+y+z is in the range of 1 to 1500;

even more preferably Rₐ, R_{b}, R_{c}, R_{g}, Rₘ and Rₑ independently of each other are selected from the group consisting of linear or branched, substituted or unsubstituted C₁-C₂₀ alkyl, linear or branched, substituted or unsubstituted C₂-C₂₀ alkenyl, substituted or unsubstituted, linear or branched 2- to 20-membered heteroalkyl, substituted or unsubstituted C₅-C₂₀ cycloalkyl, substituted or unsubstituted C₆-C₂₀ aryl, substituted or unsubstituted C₁-C₁₀ alkylene C₅-C₁₀ cycloalkyl, substituted or unsubstituted C₁-C₁₀ alkylene 5- to 10-membered heterocycloalkyl, substituted or unsubstituted C₁-C₁₀ alkylene 5- to 20-membered heterocycloalkenyl, substituted or unsubstituted C₁-C₁₀ alkylene C₆-C₂₀ aryl and substituted or unsubstituted C₁-C₁₀ alkylene 5- to 20-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl, substituted or unsubstituted C₁-C₁₀ alkylene C₅-C₃₀ cycloalkyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, and propyl;

n is an integer in the range of 1 to 300;

w is an integer in the range of 0 to 5;

t, x, y and z are independent of each and an integer in the range of 0 to 300, with the provision that the sum of t+x+y+z is in the range of 1 to 900;

most preferably the Rₐ, R_{b}, Rₑ, R_{g}, Rₘ and Rₑ independently of each other are selected from the group consisting of linear or branched, substituted or unsubstituted C₁-C₁₅ alkyl, linear or branched, substituted or unsubstituted C₂-C₁₅ alkenyl, substituted or unsubstituted C₅-C₁₅ cycloalkyl, substituted or unsubstituted C₆-C₁₀ aryl, substituted or unsubstituted C₁-C₁₀ alkylene C₅-C₁₅ cycloalkyl, and substituted or unsubstituted C₁-C₁₀ alkylene C₆-C₁₅ aryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, and propyl;

n is an integer in the range of 1 to 100;

w is an integer in the range of 1 to 3;

t, x, y and z are independent of each and an integer in the range of 0 to 100, with the provision that the sum of t+x+y+z is in the range of 1 to 300; and

in particular the Rₐ, R_{b}, R_{c}, R_{g}, Rₘ and Rₑ independently of each other are selected from the group consisting of linear or branched, substituted or unsubstituted C₁-C₁₀ alkyl, substituted or unsubstituted C₅-C₁₀ cycloalkyl, substituted or unsubstituted C₆-C₁₀ aryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl and —(CH₂)_{w}—(OCH(R₇)—CH(R₈))ₜ—NHRₑ;

Rₕ and Rₖ independently of each other are selected from the group consisting of hydrogen and —(CH₂)_{w}—(OCH(R₇)—CH(R₈))ₜ—NHRₑ;

Rⱼ and R_{f} are —(CH₂)_{w}—(OCH(R₇)—CH(R₈))ₜNHRₑ;

R₁, R₂, R₃, R₄, R₅, R₆, R₇ and R₈ independently of each other are selected from the group consisting of hydrogen, and methyl;

n is an integer in the range of 1 to 100;

w is an integer in the range of 1 to 3;

t, x, y and z are independent of each and an integer in the range of 0 to 50, with the provision that the sum of t+x+y+z is in the range of 1 to 150.

In another preferred embodiment, Rₐ, R_{b}, Rₑ, R_{g}, Rₘ and Rₑ independently of each other are selected from the group consisting of linear or branched, substituted or unsubstituted C₁-C₂₀ alkyl, linear or branched, substituted or unsubstituted C₂-C₃₀ alkenyl, substituted or unsubstituted C₅-C₁₀ cycloalkyl, substituted or unsubstituted C₅-C₁₀ cycloalkenyl, substituted or unsubstituted aryl and substituted or unsubstituted aralkyl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₂₀ cycloalkyl, substituted or unsubstituted C₅-C₂₀ cycloalkenyl, substituted or unsubstituted aryl, substituted or unsubstituted aralkyl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 300;

w is an integer in the range of 0 to 30;

t, x, y and z are independent of each and an integer in the range of 0 to 300, with the provision that the sum of t+x+y+z is in the range of 1 to 900.

In another preferred embodiment, at least one isocyanate reactive component (B) is present as a mixture of primary, secondary and tertiary amine, with major part comprising secondary amines. It is also understood that the same molecules may have one primary or more amine functional group with at least one secondary amine functional group. Similarly, the same molecules may have one tertiary or more amine functional group with at least one secondary amine functional group. Similarly, the same molecules may have one primary or more and/or one tertiary amine functional group with at least one secondary amine functional group.

In another preferred embodiment, the primary amine is present in the at least one isocyanate reactive component (B) is in the range of 0 to 10 wt % based on overall weight of the isocyanate reactive component (B), more preferably the primary amine is present in the at least one isocyanate reactive component (B) is in the range of 0 to 8 wt % based on overall weight of the isocyanate reactive component (B), even more preferably the primary amine is present in the at least one isocyanate reactive component (B) is in the range of 0.5 to 5 wt % based on overall weight of the isocyanate reactive component (B), most preferably the primary amine is present in the at least one isocyanate reactive component (B) is in the range of 1 to 4 wt % based on overall weight of the isocyanate reactive component (B), and in particular the primary amine is present in the at least one isocyanate reactive component (B) is in the range of 1 to 3 wt % based on overall weight of the isocyanate reactive component (B).

For the purposes of the presently claimed invention, the term “alkyl” covers acyclic saturated hydrocarbon residues, which may be branched or linear and unsubstituted or at least monosubstituted with, as in the case of C₁-C₃₀ alkyl, 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkyl, 1 to 5 (i.e. 1, 2, 3, 4 or 5) C atoms. If one or more of the substituents denote an alkyl residue or comprise an alkyl residue which is mono- or polysubstituted, this may preferably be substituted with 1, 2, 3, 4 or 5, particularly preferably with 1, 2 or 3, substituents mutually independently selected from the group consisting of F, Cl, Br, I, —NO₂, —CN, —OH, —SH, —NH₂, —N(C₁₋₅-alkyl)₂, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—)-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)—phenyl, —S(═O)₂—C₁₋₅-alkyl, —S(═O)₂-phenyl, —S(═O)₂—NH₂ and —SO₃H, wherein the above-stated C₁₋₅-alkyl residues may in each case be linear or branched and the above-stated phenyl residues may preferably be substituted with 1, 2, 3, 4 or 5 substituents mutually independently selected from the group consisting of F, Cl, Br, I, —CN, —CF₃, —OH, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —OH, —SH, —NH₂, —N(CH₃)₂, —N(C₂H₅)₂ and —N(CH₃)(C₂H₅).

In another preferred embodiment, the unsubstituted linear C₁-C₃₀ alkyl is preferably selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; more preferably selected from the group consisting of hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; even more preferably selected from the group consisting of methyl, ethyl, propyl, butyl, pentyl, hexyl, heptyl, octyl, nonyl, decyl, undecyl, dodecyl, tridecyl, tetradecyl and pentadecyl; most preferably selected from the group consisting of methyl, ethyl, propyl, butyl, pentyl, hexyl, heptyl, octyl, nonyl, decyl, undecyl and dodecyl; and in particular selected from the group consisting of methyl, ethyl, propyl, butyl, pentyl, hexyl, heptyl, octyl, nonyl and decyl.

In another preferred embodiment, the unsubstituted branched C₁-C₃₀ alkyl is preferably selected from the group consisting of isopropyl, iso-butyl, neo-pentyl, 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, iso-decyl, iso-dodecyl, iso-tetradecyl, iso-hexadecyl, iso-octadecyl and iso-eicosyl, more preferably selected from the group consisting of 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, iso-decyl, iso-dodecyl, iso-tetradecyl, iso-hexadecyl, iso-octadecyl, iso-eicosyl, 2-methyltricosyl, 2-ethyldocosyl, 3-ethylhenicosyl, 3-ethylicosyl, 4-propylhenicosyl, propylnonadecyl, 6-butyldodecyl and 5-ethylundecyl. The polysubstituted alkyl residues are understood to be those alkyl residues which are either poly-, preferably di- or trisubstituted, either on different or on the same C atoms, for example trisubstituted on the same C atom as in the case of —CF₃, or at different locations as in the case of —(CHCl)—(CH₂F). Polysubstitution may proceed with identical or different substituents. Examples which may be mentioned of suitable substituted alkyl residues are —CF₃, —CF₂H, —CFH₂, —(CH₂)—OH, —(CH₂)—NH₂, —(CH₂)—CN, —(CH₂)—(CF₃), —(CH₂)—(CH₂), —(CH₂)—(CH₂F), —(CH₂)—(CH₂)—OH, —(CH₂)—(CH₂)—NH₂, —(CH₂)—(CH₂)—CN, —(CF₂)—(CF₃), —(CH₂)—(CH₂)—(CF₃), and —(CH₂)—(CH₂)—(CH₂)—OH.

In another preferred embodiment, the substituted, linear or branched, C₁-C₃₀ alkyl refers to a branched or linear saturated hydrocarbon group having C₁-C₃₀ carbon atoms substituted with functional groups selected from the group consisting of F, Cl, Br, I, —NO₂, —CN, —OH, —SH, —NH₂, —N(C₁₋₅-alkyl)₂, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —O(═O)—C₁₋₅-alkyl, —C(═O)-phenyl, —O(═S)—C₁₋₅-alkyl, —C(═S)-phenyl, —C(═O)—OH, —O(═O)—O—C₁₋₅-alkyl, —C(═O)—)-phenyl, —C(═O)—NH₂, —O(═O)—NH—C₁₋₅-alkyl, —O(═O)—N(C₁₋₅-alkyl)₂, —S(═O)—-C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated C₁₋₅-alkyl residues may in each case be linear or branched and the above-stated phenyl residues may preferably be substituted with 1, 2, 3, 4 or 5 substituents mutually independently selected from the group consisting of F, Cl, Br, I, —CN, —CF₃, —OH, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —OH, —SH, —NH₂, —N(CH₃)₂, —N(C₂H₅)₂ and —N(CH₃)(C₂H₅).

In another preferred embodiment, the substituted, linear or branched, C₁-C₃₀ alkyl refers to a branched or linear saturated hydrocarbon group having C₁-C₃₀ carbon atoms substituted with functional groups selected from the group consisting of hydroxy, alkoxy, C(═O)R, CN and SR, preferably selected from the group consisting of 1-hydroxy methyl, 1-methoxy methyl, 1-hydroxy ethyl, 1-hydroxy propyl, 1-hydroxy butyl, 1-hydroxy pentyl, 1-hydroxy hexyl, 1-hydroxy heptyl, 1-hydroxy octyl, 1-hydroxy nonyl, decyl, 1-hydroxy undecyl, 1-hydroxy dodecyl, 1-hydroxy tridecyl, 1-hydroxy tetradecyl, 1-hydroxy pentadecyl, 1-hydroxy hexadecyl, 1-hydroxy heptadecyl, 1-hydroxy octadecyl, 1-hydroxy nonadecyl, 1-hydroxy eicosyl, 1-hydroxy henicosyl, 1-hydroxy docosyl, 1-hydroxy tricosyl, 1-hydroxy tetracosyl, 1-methoxy methyl, 1-methoxy ethyl, 1-methoxy propyl, 1-methoxy butyl, 1-methoxy pentyl, 1-methoxy hexyl, 1-methoxy heptyl, 1-methoxy octyl, 1-methoxy nonyl, decyl, 1-methoxy undecyl, 1-methoxy dodecyl, 1-methoxy tridecyl, 1-methoxy tetradecyl, 1-methoxy pentadecyl, 1-methoxy hexadecyl, 1-methoxy heptadecyl, 1-methoxy octadecyl, 1-methoxy nonadecyl, 1-methoxy eicosyl, 1-methoxy henicosyl, 1-methoxy docosyl, 1-methoxy tricosyl, 1-methoxy tetracosyl, 2-methoxy propyl, 2-methoxy butyl, 2-methoxy pentyl, 2-methoxy hexyl, 2-methoxy heptyl, 2-methoxy octyl, 2-methoxy nonyl, decyl, 2-methoxy undecyl, 2-methoxy dodecyl, 2-methoxy tridecyl, 2-methoxy tetradecyl, 2-methoxy pentadecyl, 2-methoxy hexadecyl, 2-methoxy heptadecyl, 2-methoxy octadecyl, 2-methoxy nonadecyl, 2-methoxy eicosyl, 2-methoxy henicosyl, 2-methoxy docosyl, 2-methoxy tricosyl, 2-methoxy tetracosyl, 1-acetoxy methyl, 1-acetoxy ethyl, 1-acetoxy propyl, 1-acetoxy butyl, 1-acetoxy pentyl, 1-acetoxy hexyl, 1-acetoxy heptyl, 1-acetoxy octyl, 1-acetoxy nonyl, decyl, 1-acetoxy undecyl, 1-acetoxy dodecyl, 1-acetoxy tridecyl, 1-acetoxy tetradecyl, 1-acetoxy pentadecyl, 1-acetoxy hexadecyl, 1-acetoxy heptadecyl, 1-acetoxy octadecyl, 1-acetoxy nonadecyl, 1-acetoxy eicosyl, 1-acetoxy henicosyl, 1-acetoxy docosyl, 1-acetoxy tricosyl, 1-acetoxy tetracosyl, 1-cyano methyl, 1-cyano ethyl, 1-cyano propyl, 1-cyano butyl, 1-cyano pentyl, 1-cyano hexyl, 1-cyano heptyl, 1-cyano octyl, 1-cyano nonyl, decyl, 1-cyano undecyl, 1-cyano dodecyl, 1-cyano tridecyl, 1-cyano tetradecyl, 1-cyano pentadecyl, 1-cyano hexadecyl, 1-cyano heptadecyl, 1-cyano octadecyl, 1-cyano nonadecyl, 1-cyano eicosyl, 1-cyano henicosyl, 1-cyano docosyl, 1-cyano tricosyl, 1-cyano tetracosyl, 2-cyano propyl, 2-cyano butyl, 2-cyano pentyl, 2-cyano hexyl, 2-cyano heptyl, 2-cyano octyl, 2-cyano nonyl, decyl, 2-cyano undecyl, 2-cyano dodecyl, 2-cyano tridecyl, 2-cyano tetradecyl, 2-cyano pentadecyl, 2-cyano hexadecyl, 2-cyano heptadecyl, 2-cyano octadecyl, 2-cyano nonadecyl, 2-cyano eicosyl, 2-cyano henicosyl, 2-cyano docosyl, 2-cyano tricosyl, 2-cyano tetracosyl, 1-thioyl methyl, 1-thioyl ethyl, 1-thioyl propyl, 1-thioyl butyl, 1-thioyl pentyl, 1-thioyl hexyl, 1-thioyl heptyl, 1-thioyl octyl, 1-thioyl nonyl, decyl, 1-thioyl undecyl, 1-thioyl dodecyl, 1-thioyl tridecyl, 1-thioyl tetradecyl, 1-thioyl pentadecyl, 1-thioyl hexadecyl, 1-thioyl heptadecyl, 1-thioyl octadecyl, 1-thioyl nonadecyl, 1-thioyl eicosyl, 1-thioyl henicosyl, 1-thioyl docosyl, 1-thioyl tricosyl and 1-thioyl tetracosyl.

In another preferred embodiment, the term alkenyl denotes unsubstituted, linear C₂-C₃₀ alkenyl which is preferably selected from the group consisting of 1-propenyl, 1-butenyl, 1-pentenyl, 1-hexenyl,2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl,2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, more preferably selected from 1-hexenyl, 2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl, 2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, 20-henicosenyl, 2-docosenyl, 6-tricosenyl and 2-tetracosenyl.

In another preferred embodiment, the unsubstituted branched C₂-C₃₀ alkenyl is selected from the group consisting of isopropenyl, iso-butenyl, neo-pentenyl, 2-ethyl-hexenyl, 2-propyl-heptenyl, 2-butyl-octenyl, 2-pentyl-nonenyl, 2-hexyl-decenyl, iso-hexenyl, iso-heptenyl, iso-octenyl, iso-nonenyl, iso-decenyl, iso-dodecenyl, iso-tetradecenyl, iso-hexadecenyl, iso-octadecenyl, iso-eicosenyl, 2-methyl tricosenyl, 2-ethyl docosenyl, 3-ethylhenicosenyl, 3-ethyl icosenyl, 4-propylhenicosenyl, 4-propylnonadecenyl, 6-butyldodecenyl, 5-ethylundedcenyl, 1,4-hexadienyl, 1,3-hexadienyl, 2,5-hexadienyl, 3,5-hexadienyl, 2,4-hexadienyl, 1,3,5-hexatrienyl, 1,3,6-heptatrienyl, 1,4,7-octatrienyl or 2-methyl-1,3,5hexatrienyl, 1,3,5,7-octatetraenyl, 1,3,5,8-nonatetraenyl, 1,4,7,10-undecatetraenyl, 2-ethyl-1,3,6,8-nonatetraenyl, 2-ethenyl-1,3,5,8-nonatetraenyl, 1,3,5,7,9-decapentaenyl, 1,4,6,8,10-undecapentaenyl, and 1,4,6,9,11 -dodecapentaenyl.

In another preferred embodiment, the substituted, linear or branched, C₂-C₃₀ alkenyl refers to a branched or an linear unsaturated hydrocarbon group having C₂-C₃₀ carbon atoms substituted with functional groups selected from, hydroxy, alkoxy, C(═O)R, CN and SR; wherein R is hydrogen, substituted or unsubstituted, linear or branched C₁-C₃₀ alkyl, substituted or unsubstituted, linear or branched C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted C₇-C₃₀ arylalkyl.

In another preferred embodiment, the term “alkenyl” refers to a branched or an linear unsaturated hydrocarbon group having C₂-C₃₀ carbon atoms substituted with functional groups selected from, hydroxy, alkoxy, C(═O)R, CN and SR; preferably selected from the group consisting of 2-hydroxy propenyl, 3-hydroxy butenyl, 3-hydroxy pentenyl, 5-hydroxy hexenyl, 7-hydroxy heptenyl, 3-hydroxy octenyl, 5-hydroxy nonenyl, decyl, 11-hydroxy undecenyl, 9-hydroxy dodecenyl, 6-hydroxy tridecenyl, 4-hydroxy tetradecenyl, 6-hydroxy pentadecenyl, 3-hydroxy hexadecenyl, 2-hydroxy heptadecenyl, 7-hydroxy octadecenyl, 6-hydroxy nonadecenyl, 4-hydroxy eicosenyl, 2-hydroxy henicosenyl, 3-hydroxy docosenyl, 2-hydroxy tricosenyl, 23-hydroxy tetracosenyl, 1-methoxy ethenyl, 2-methoxy propenyl, 4-methoxy butenyl, 3-methoxy pentenyl, 5-methoxy hexenyl, 2-methoxy heptenyl, 5-methoxy octenyl, 3-methoxy nonenyl, 6-methoxy undecenyl, 1-methoxy dodec-2-enyl, 1-methoxy tridec-5-enyl, 3-methoxy tetradic-5-enyl, 3-methoxy pentade-12-encyl, 10-methoxy hexadec-15-enyl, 12-methoxy heptadic-1 6-enyl,1-methoxy octadec-3-enyl, 1-methoxy nonadec-2-enyl, 1-methoxy eicos-20-enyl, 1-methoxy henicos-2-enyl, 1-methoxy docos-4-enyl, 1-methoxy tricos-22-enyl, 1-methoxy tetracos-23-enyl, 2-methoxy prop-1-enyl, 2-methoxy but-1-enyl, 2-methoxy pent-4-enyl, 2-methoxy hex-2-enyl, 2-methoxy hept-3-enyl, 2-methoxy oct-7-enyl, 2-methoxy non-5-enyl, 2-methoxy undec-10-enyl, 2-methoxy dodec-4-enyl, 2-methoxy tridec-12-enyl, 2-methoxy tetradic-10-enyl, 2-methoxy pentadec-14-enyl, 2-methoxy hexadec-1-enyl, 2-methoxy heptadic-1-enyl, 2-methoxy octadic-12-enyl, 2-methoxy nonadec-10-enyl, 2-methoxy eicos-18-enyl, 2-methoxy henicos-2-enyl, 2-methoxy docos-3-enyl, 20-methoxy tricos-2-enyl, 21-methoxy tetracos-4-enyl, 1-acetoxy ethenyl, 1-acetoxy prop-1-enyl, 1-acetoxy but-2-enyl, 1-acetoxy pent-4-enyl, 1-acetoxy hex-2-enyl, 1-acetoxy hept-1-enyl, 1-acetoxy oct-7-enyl, 1-acetoxy non-2-enyl, 5-acetoxy dec-3-enyl, 1-acetoxy undec-10-enyl, 1-acetoxy dodec-2-enyl, 1-acetoxy tridec-12-enyl, 10-acetoxy tetradec-2-enyl, 15-acetoxy pentadec-2-enyl, 10-acetoxy hexadec-2-enyl, 11-acetoxy heptadec-1-enyl, 13-acetoxy octadec-2-enyl, 1-acetoxy nonadec-14-enyl, 20-acetoxy eicos-19-enyl, 1-acetoxy henicos-2-enyl, 1-acetoxy docos-10-enyl, 1-acetoxy tricos-22-enyl, 1-acetoxy tetracos-23-enyl, 1-cyano eth-1-enyl, 1-cyano prop-2-enyl, 1-cyano but-2-enyl, 1-cyano pent-3-enyl, 1-cyano hex-5-enyl, 1-cyano hept-6-enyl, 1-cyano oct-2-enyl, 1-cyano non-3-enyl, 11-cyano undec-2-enyl, 10-cyano dodec-2-enyl, 10-cyano tridec-12-enyl, 1-cyano tetradec-3-enyl, 1-cyano pentadec-14-enyl, 1-cyano hexadec-15-enyl, 1-cyano heptadec-2-enyl, 1-cyano octadec-3-enyl, 1-cyano nonadec-18-enyl, 1-cyano eicos-10-enyl, 1-cyano henicos-20-enyl, 15-cyano docos-3-enyl, 1-cyano tricos-20-enyl, 1-cyano tetracos-2-enyl, 2-cyano prop-2-enyl, 2-cyano but-1-enyl, 2-cyano pent-1-enyl, 2-cyano hex-3-enyl, 2-cyano hept-6-enyl, 2-cyano oct-1-enyl, 2-cyano non-8-enyl, 2-cyano undec-10-enyl, 2-cyano dodec-1-enyl, 2-cyano tridec-12-enyl, 2-cyano tetradec-10-enyl, 2-cyano pentadec-3-enyl, 2-cyano hexadec-2-enyl, 2-cyano heptadec-1-enyl, 2-cyano octadec-12-enyl, 2-cyano nonadec-15-enyl, 2-cyano eicos-1-enyl, 2-cyano henicos-5-enyl, 2-cyano docos-20-enyl, 2-cyano tricos-22-enyl, 2-cyano tetracos-20-enyl, 1-thionyl eth-1-enyl, 1-thionyl prop-2-enyl, 1-thionyl but-2-enyl, 1-thionyl pent-4-enyl, 1-thionyl hex-2-enyl, 1-thionyl hept-5-enyl, 1-thionyl oct-3-enyl, 1-thionyl non-5-enyl, 1-thionyl undec-10-enyl, 1-thionyl dodec-11-enyl, 1-thionyl tridec-2-enyl, 1-thionyl tetradec-4-enyl, 1-thionyl pentadec-5-enyl, 1-thionyl hexadec-3-enyl, 1-thionyl heptadec-2-enyl, 1-thionyl octadec-3-enyl, 1-thionyl nonadec-15-enyl, 1-thionyl eicos-18-enyl, 1-thionyl henicos-20-enyl, 1-thionyl docos-21-enyl, 1-thionyl tricos-20-enyl and 1-thionyl tetracos-22-enyl.

In a preferred embodiment, the term “heteroalkyl” refers to an alkyl group, in which one or more carbon atoms have in each case been replaced by a heteroatom mutually independently selected from the group consisting of oxygen, sulfur and nitrogen (NH). Heteroalkyl residues preferably comprise 1, 2 or 3 heteroatom(s) mutually independently selected from the group consisting of oxygen, sulfur and nitrogen (NH) as chain link(s). Heteroalkyl residues may preferably be 2- to 12-membered, particularly preferably 2- to 6-membered. Examples of heteroalkyl groups include, but are not limited to, alkoxy, poly(ethylene glycol)- and alkyl-substituted amino.

In another preferred embodiment, the term “heteroalkenyl” refers to an alkenyl group, wherein at least one atom is a heteroatom selected from oxygen, nitrogen or sulphur. Heteroalkenyl residues preferably comprise 1, 2 or 3 heteroatom(s) mutually independently selected from the group consisting of oxygen, sulfur and nitrogen (NH) as chain link(s). Heteroalkenyl residues may preferably be 3- to 12-membered, particularly preferably 3- to 6-membered. Examples of heteroalkenyl groups include, but are not limited to, selected from the group consisting of —CH₂—O—CH═CH₂, —CH═CH—O—CH═CH—CH₃, —CH₂—CH₂—O—CH═CH₂, —CH₂—S—CH═CH₂, —CH═CH—S—CH═CH—CH₃, —CH₂—CH₂—S—CH═CH₂, —CH₂—NH—CH═CH₂, —CH═CH—NH—CH═CH—CH₃ and —CH₂—CH₂—NH—CH═CH₂; more preferably the heteroalkenyl selected from the group consisting of —CH₂—O—CH═CH—(CH₂)—OH, —CH₂—S—CH═CH—(CH₂)—NH₂ and —CH₂—NH—CH═CH—CN.

In a preferred embodiment, the term “cycloalkyl” refers to a monocyclic and bicyclic 5 to 30 membered saturated cycloaliphatic radical. Representative examples of unsubstituted or branched C₅-C₃₀ monocyclic and bicyclic cycloalkyl include, but are not limited to, cyclopentyl, cyclohexyl, cycloheptyl, cyclooctyl, cyclononyl, bicyclo[2.2.1]heptyl, (1,2,3,4)-tetrahydroquinolinyl, (1,2,3,4)-tetrahydroisoquinolinyl, (2,3)-dihydro-1H-isoindolyl, (1,2,3,4)-tetrahydronaphthyl, (2,3)-dihydrobenzo[1.4]dioxinyl, benzo[1.3]dioxolyl, (3,4)-dihydro-2H-benzo[1.4]oxazinyl and octahydro-pyrrolo[3,4-c]pyrrolyl and bicyclo[3.1.1]heptyl.

In another preferred embodiment, the C₅-C₃₀ monocyclic and bicyclic cycloalkyl can be further branched with one or more equal or different alkyl groups such as methyl, ethyl, n-propyl, iso-propyl, n-butyl, iso-butyl, n-pentyl, iso-pentyl, neo-pentyl etc. The representative examples of branched C₃-C₁₀ monocyclic and bicyclic cycloalkyl include, but are not limited to, methyl cyclohexyl and dimethyl cyclohexyl.

In another preferred embodiment, the term “cycloalkenyl” refers to a monocyclic and bicyclic 5 to 30 membered unsaturated cycloaliphatic radical, which comprises one or more double bonds. Representative examples of C₅-C₃₀ cycloalkenyl include, but are not limited to, cyclopentenyl, cyclohexenyl, cycloheptenyl, cyclooctenyl, cyclononenyl or cyclodecenyl. These radicals can be branched with one or more equal or different alkyl radical, preferably with methyl, ethyl, n-propyl or iso-propyl. The representative examples of branched C₅-C₃₀ monocyclic and bicyclic cycloalkenyl include, but are not limited to, methyl cyclohexenyl and dimethyl cyclohexenyl.

In another preferred embodiment, the term “heterocycloalkyl ” means a non-aromatic monocyclic or polycyclic ring comprising 5 to 30 carbon atoms and at least one heteroatom selected from O, S, and N. Preferably the examples include but not limited to aziridinyl, pyrrolidinyl, pyrrolidino, piperidinyl, piperidino, piperazinyl, piperazino, morpholinyl, morpholino, thiomorpholinyl, thiomorpholino, tetrahydrofuranyl, tetrahydrothiofuranyl, tetrahydropyranyl, pyranyl, imidazolidinyl, tetrahydrofuranyl, tetrahydrothiophenyl, pyrrolidinyl, piperidinyl, morpholinyl, piperazinyl, thiomorpholinyl, tetrahydropyranyl, oxetanyl, azepanyl, azocanyl, diazepanyl, dithiolanyl, (1,3)-dioxolan-2-yl, isoxazolidinyl, isothioazolidinyl, pyrazolidinyl, oxazolidinyl, (1,2,4)-oxadiazolidinyl, (1,2,4)-thiadiazolidinyl, (1,2,4)-triazolidin-3-yl, (1,3,4)-thiadiazolidin-2-yl, (1,3,4)-triazolidin-1-yl, (1,3,4)-triazolidin-2-yl, tetrahydropyridazinyl, tetrahydropyrimidinyl, tetrahydropyrazinyl, (1,3,5)-tetrahydrotriazinyl, (1,2,4)-tetrahydrotriazin-1-yl, (1,3)-dithian-2-yl and (1,3)-thiazolidinyl.

In another preferred embodiment, the term “heterocycloalkenyl ” means a non-aromatic monocyclic or polycyclic ring comprising 5 to 30 carbon atoms with at least one heteroatom selected from O, S, and N and having at least one double bond. The example include, but not limited to, (2,3)-dihydrofuranyl, (2,3)-dihydrothienyl, (2,3)-dihydropyrrolyl, (2,5)-dihydropyrrolyl, (2,5)-dihydropyrrolyl, (2,3)-dihydroisoxazolyl, (1,4)-dihydropyridin-1-yl, di-hydropyranyl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 4,5-dihydropyrazol-2-yl, 4,5-dihydropyrazol-3-yl, 4,5-dihydropyrazol- 4-yl, 4,5-dihydropyrazol-5-yl, 2,5-dihydrothienyl and (1,2,3,4)-tetrahydropyridin-1-yl.

In another preferred embodiment, the term “heteroalkyl, heteroalkenyl, cycloalkyl, cycloalkenyl, heterocycloalkyl and heterocycloalkenyl” also refers to mono- or polysubstituted with 1, 2, 3, 4 or 5, more preferably with 1, 2 or 3, substituents which may be mutually independently selected from the group consisting of F, Cl, Br, I, —CN, —NO₂, —OH, —SH, —NH₂, oxo (═O), thioxo (═S), —C(═O)—OH, C₁₋₅ alkyl, —C₂₋₅ alkenyl, —C₂₋₅ alkynyl, —C≡C—Si(CH₃)₃, —C≡C—Si(C₂H₅)₃, —(CH₂)—O—C₁₋₅-alkyl, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl)(C₁₋₅-alkyl), —C(═O)—O—C₁₋₅-alkyl, —C(═O)—H, —C(═O)—C₁₋₅-alkyl, —CH₂—O—C(═O)—phenyl, —O—C(═O)—phenyl, —NH—S(═O)₂—₁₋₅-alkyl, —NH—C(═O)—C₁₋₅-alkyl, —C(═O)—NH₂, —C(═O)—NH—C₁₋₅-alkyl, —C(═O)—N(C₁₋₅-alkyl)₂, pyrazolyl, phenyl, furyl (furanyl), thiadiazolyl, thiophenyl (thienyl) and benzyl, wherein the above-stated C₁₋₅ alkyl residues may in each case be linear or branched and the cyclic substituents or the cyclic residues of these substituents themselves may in each case be substituted with 1, 2, 3, 4 or 5, preferably with 1, 2, 3 or 4, substituents mutually independently selected from the group consisting of F, Cl, Br, I, —CN, —CF₃, —OH, —NH₂, —O—CF₃, —SH, —O—C₁₋₅-alkyl, —O-phenyl, —O—CH₂-phenyl, —(CH₂)—O—C₁₋₅-alkyl, —S—C₁₋₅-alkyl, —S-phenyl, —S—CH₂-phenyl, —C₁₋₅ alkyl, —C₂₋₅ alkenyl, —C₂₋₅alkynyl, —C≡C—Si(CH₃)₃, —C≡C—Si(C₂H₅)₃, —C(═O)—O—C₁₋₅-alkyl and —C(═O)—CF₃.

In a preferred embodiment, the term “aryl” refers to aromatic compounds that may have more than one aromatic ring. The representative examples for substituted and unsubstituted C₆-C₃₀ aryl include phenyl, naphthyl, anthracenyl, tetraphenyl, phenalenyl and phenanthrenyl.

In another preferred embodiment, the “arylalkyl” refers to an aryl ring attached to an alkyl chain. The representative examples for the arylalkyl include, but are not limited to, 1-phenylmethyl, 1-phenylethyl, 1-phenylpropyl, 1-phenylbutyl, 1-methyl-1-phenyl-propyl, 3-phenylpropyl, 4-phenylbutyl, 3-phenylbutyl and 2-methyl-3-phenyl-propyl.

In another preferred embodiment, the term “heteroaryl” means a monocyclic or polycyclic, preferably a mono-, bi- or tricyclic aromatic hydrocarbon residue with preferably 5, 6, 7, 8, 9, 10, 11, 12, 13, 14, 15, 16, 17, 18, 19, 20, 21, 22, 23, 24, 25, 26, 27, 28, 29 or 30 C atoms, particularly preferably with 5, 6, 9, 10, 13 or 14 C atoms, very particularly preferably with 5 or 6 C atoms, in which one or more carbon atoms have been replaced with heteroatoms each independently selected from the group consisting of oxygen, sulfur and nitrogen (NH). Heteroaryl residues may preferably comprise 1, 2, 3, 4 or 5, particularly preferably 1, 2 or 3, heteroatom(s) mutually independently selected from the group consisting of oxygen, sulfur and nitrogen (NH) as ring member(s) A heteroaryl residue may be unsubstituted or monosubstituted or identically or differently polysubstituted. The examples of suitable heteroaryl residues which may be mentioned are thienyl, furyl, pyrrolyl, pyrazolyl, pyrazinyl, pyranyl, triazolyl, pyridinyl, imidazolyl, indolyl, isoindolyl, benzo[b]furanyl, benzo[b]thiophenyl, benzo[d]thiazolyl, benzodiazolyl, benzotriazolyl, benzoxazolyl, benzisoxazolyl, thiazolyl, thiadiazolyl, oxazolyl, oxadiazolyl, isoxazolyl, pyridazinyl, pyrimidinyl, indazolyl, quinoxalinyl, quinazolinyl, quinolinyl, naphthridinyl and isoquinolinyl.

For the purposes of the presently claimed invention aryl or heteroaryl residues may be fused (anellated) with a mono- or bicyclic ring system. Examples which may be mentioned of aryl residues which are fused with a mono- or bicyclic ring system are (1,2,3,4)-tetrahydroquinolinyl, (1,2,3,4)-tetrahydroisoquinolinyl, (2,3)-dihydro-1H-isoindolyl, (1,2,3,4)-tetrahydronaphthyl, (2,3)-dihydrobenzo[1.4]dioxinyl, benzo[1.3]dioxolyl and (3,4)-dihydro-2H-benzo[1.4]oxazinyl.

In another preferred embodiment, if one or more of the substituents denote an aryl, heteroaryl or arylalkyl residue or comprise an aryl or heteroaryl residue which is mono- or polysubstituted, this may preferably be substituted with 1, 2, 3, 4 or 5, particularly preferably with 1, 2 or 3, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl)₂, —C(═O)—O—C₁₋₅-alkyl, —C(═O)—H; —C(═O)—C₁₋₅-alkyl, —CH₂—O—C(═O)—phenyl, —O—C(═O)—phenyl, —NH—S(═O)₂—C₁₋₅-alkyl, —NH—C(═O)—C₁₋₅-alkyl, —C(═O)—NH₂, —C(═O)—NH—C₁₋₅-alkyl, —C(═O)—N(C₁₋₅-alkyl)₂, pyrazolyl, phenyl, furyl (furanyl), thiazolyl, thiadiazolyl, thiophenyl (thienyl), benzyl and phenethyl, wherein the above-stated C₁₋₅ alkyl residues may in each case be linear or branched and the cyclic substituents or the cyclic residues of these substituents themselves may be substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F; most preferably, the substituents in each case mutually independently selected from the group consisting of F, Cl, Br, I, —CN, —NO₂, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—C₂H₅, —SH, —NH₂, —C(═O)—OH, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)3, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, pyrazolyl, phenyl, —N(CH₃)₂, —N(C₂H₅)₂, —NH—CH₃, —NH—C₂H₅, —CH₂—O—C(═O)—phenyl, —NH—S(═O)₂—CH₃, —C(═O)—O—CH₃, —C(═O)—O—C₂H₅, —C(═O)—O—C(CH₃)₃, —C(═O)—H, —C(═O)—CH₃, —C(═O)—C₂H₅, —NH—C(═O)—CH₃, —NH—C(═O)—C₂H₅, —O—C(═O)—phenyl, —C(═O)—NH₂, —C(═O)—NH—CH₃, —C(═O)—N(CH₃)₂, phenyl, furyl (furanyl), thiadiazolyl, thiophenyl (thienyl) and benzyl, wherein the cyclic substituents or the cyclic residues of these substituents themselves may in each case be substituted with 1, 2, 3, 4, or 5, preferably with 1, 2, 3 or 4, substituents mutually independently selected from the group consisting of F, Cl, Br, I, —CN, —NO₂, —SH, —NH₂, —C(═O)—OH, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—C₂H₅, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, -S—CF₃, —S—CHF₂ and —S—CH₂F.

In another preferred embodiment, a substituted aryl residue may be selected from the group consisting of 2-methylphenyl, 3-methylphenyl, 4-methylphenyl, 2-fluorophenyl, 3-fluorophenyl, 4-fluorophenyl, 2-cyanophenyl, 3-cyanophenyl, 4-cyanophenyl, 2-aminophenyl, 3-aminophenyl, 4-aminophenyl, 2-dimethylaminophenyl, 3-dimethylaminophenyl, 4-dimethylaminophenyl, 2-methylaminophenyl, 3-methylaminophenyl, 4-methylaminophenyl, 2-acetylphenyl, 3-acetylphenyl, 4-acetylphenyl, 2-methylsulfinylphenyl, 3-methylsulfinylphenyl, 4-methylsulfinylphenyl, 2-methylsulfonylphenyl, 3-methylsulfonylphenyl, 4-methylsulfonylphenyl, 2-methoxyphenyl, 3-methoxyphenyl, 4-methoxyphenyl, 2-chlorophenyl, 3-chlorophenyl, 4-chlorophenyl, 2-ethoxyphenyl, 3-ethoxyphenyl, 4-ethoxyphenyl, 2-trifluoromethylphenyl, 3-trifluoromethylphenyl, 4-trifluoromethyl phenyl, 2-difluoromethylphenyl, 3-difluoromethylphenyl, 4-difluoromethylphenyl, 2-fluoromethylphenyl, 3-fluoromethylphenyl, 4-fluoromethylphenyl, 2-nitrophenyl, 3-nitrophenyl, 4-nitrophenyl, 2-ethylphenyl, 3-ethylphenyl, 4-ethylphenyl, 2-propylphenyl, 3-propylphenyl, 4-propylphenyl, 2-isopropylphenyl, 3-isopropylphenyl, 4-isopropylphenyl, 2-tert.-butylphenyl, 3-tert.-butylphenyl, 4-tert.-butylphenyl, 2-carboxyphenyl, 3-carboxyphenyl, 4-carboxyphenyl, 2-ethenylphenyl, 3-ethenylphenyl, 4-ethenylphenyl, 2-ethynylphenyl, 3-ethynylphenyl, 4-ethynylphenyl, 2-allylphenyl, 3-allylphenyl, 4-allylphenyl, 2-trimethylsilanylethynylphenyl, 3-trimethylsilanylethynylphenyl, 4-trimethylsilanylethynylphenyl, 2-formylphenyl, 3-formylphenyl, 4-formylphenyl, 2-acetaminophenyl, 3-acetaminophenyl, 4-acetaminophenyl, 2-dimethylam inocarbonylphenyl, 3-dimethylaminocarbonylphenyl, 4-dimethylaminocarbonylphenyl, 2-methoxymethyl phenyl, 3-methoxymethylphenyl, 4-methoxymethylphenyl, 2-ethoxymethylphenyl, 3-ethoxymethylphenyl, 4-ethoxymethylphenyl, 2-aminocarbonylphenyl, 3-aminocarbonylphenyl, 4-aminocarbinophenyl, 2-methylaminocarbonylphenyl, 3-methylaminocarbonylphenyl, 4-methylaminocarbonylphenyl, 2-carboxymethyl ester phenyl, 3-carboxymethyl ester phenyl, 4-carboxymethyl ester phenyl, 2-carboxyethyl ester phenyl, 3-carboxyethyl ester phenyl, 4-carboxyethyl ester phenyl, 2-carboxy-tert.-butyl ester phenyl, 3-carboxy-tert.-butyl ester phenyl, 4-carboxy-tert.-butyl ester phenyl, 2-methylmercaptophenyl, 3-methylmercaptophenyl, 4- methylmercaptophenyl, 2-ethylmercaptophenyl, 3-ethylmercaptophenyl, 4-ethylmercaptophenyl, 2-biphenyl, 3-biphenyl, 4-biphenyl, 2-bromophenyl, 3-bromophenyl, 4-bromophenyl, 2-iodophenyl, 3-iodophenyl, 4-iodophenyl, 2-trifluoromethoxyphenyl, 3-trifluoromethoxyphenyl, 4-trifluoro-methoxyphenyl, 2-fluoro-3-trifluoromethylphenyl, 2-fluoro-4-methylphenyl, (2,3)-difluorophenyl, (2,3)-dimethylphenyl, (2,3)-dichlorophenyl, 3-fluoro-2-trifluoro-methylphenyl, (2,4)-dichlorophenyl, (2,4)-difluorophenyl, 4-fluoro-2-trifluoromethylphenyl, (2,4)-dimethoxyphenyl, 2-chloro-4-fluorophenyl, 2-chloro-4-nitrophenyl, 2-chloro-4-methylphenyl, 2-chloro-5-trifluoromethylphenyl, 2-chloro-5-methoxyphenyl, 2-bromo-5-trifluoromethylphenyl, 2-bromo-5-methoxyphenyl, (2,4)-dibromophenyl, (2,4)-dimethylphenyl, 2-fluoro-4-trifluoromethylphenyl, (2,5)-difluorophenyl, 2-fluoro-5-trifluoro-methylphenyl, 5-fluoro-2-trifluoromethylphenyl, 5-chloro-2-trifluoromethylphenyl, 5-bromo-2-trifluoromethylphenyl, (2,5)-dimethoxyphenyl, (2,5)-bis-trifluoromethylphenyl, (2,5)-dichlorophenyl, (2,5)-dibromophenyl, 2-methoxy-5-nitrophenyl, 2-fluoro-6-trifluoro-methylphenyl, (2,6)-dimethoxyphenyl, (2,6)-dimethylphenyl, (2,6)-dichlorophenyl, 2-chloro-6-fluorophenyl, 2-bromo-6-chlorophenyl, 2-bromo-6-fluorophenyl, (2,6)-difluorophenyl, (2,6)-difluoro-3-methylphenyl, (2,6)-dibromophenyl, (2,6)-dichlorophenyl, 3-chloro-2-fluorophenyl, 3-chloro-5-methylphenyl, (3,4)-dichlorophenyl, (3,4)-dimethylphenyl, 3-methyl-4-methoxyphenyl, 4-chloro-3-nitrophenyl, (3,4)-dimethoxyphenyl, 4-fluoro-3-trifluoromethylphenyl, 3-fluoro-4-trifluoromethylphenyl, (3,4)-difluorophenyl, 3-cyano-4-fluorophenyl, 3-cyano-4-methylphenyl, 3-cyano-4-methoxyphenyl, 3-bromo-4-fluorophenyl, 3-bromo-4-methylphenyl, 3-bromo-4-methoxyphenyl, 4-chloro-2-fluorophenyl, 4-chloro-3-trifluoromethyl, 4-bromo-3-methylphenyl, 4-bromo-5-methylphenyl, 3-chloro-4-fluorophenyl, 4-fluoro-3-nitrophenyl, 4-bromo-3-nitrophenyl, (3,4)-dibromophenyl, 4-chloro-3-methylphenyl, 4-bromo-3-methylphenyl, 4-fluoro-3-methylphenyl, 3-fluoro-4-methylphenyl, 3-fluoro-5-methylphenyl, 2-fluoro-3-methylphenyl, 4-methyl-3-nitrophenyl, (3,5)-dimethoxyphenyl, (3,5)-dimethylphenyl, (3,5)-bis-trifluoromethylphenyl, (3,5)-difluorophenyl, (3,5)-dinitrophenyl, (3,5)-dichlorophenyl, 3-fluoro-5-trifluoromethylphenyl, 5-fluoro-3-trifluoro-methylphenyl, (3,5)-dibromophenyl, 5-chloro-4-fluorophenyl, 5-chloro-4-fluorophenyl, 5-bromo-4-methylphenyl, (2,3,4)-trifluorophenyl, (2,3,4)-trichlorophenyl, (2,3,6)-trifluorophenyl, 5-chloro-2-methoxyphenyl, (2,3)-difluoro-4-methyl, (2,4,5)-trifluorophenyl, (2,4,5)-trichlorophenyl, (2,4)-dichloro-5-fluorophenyl, (2,4,6)-trichlorophenyl, (2,4,6)-trimethylphenyl, (2,4,6)-trifluorophenyl, (2,4,6)-trimethoxyphenyl, (3,4,5)-trimethoxyphenyl, (2,3,4,5)-tetrafluorophenyl, 4-methoxy-(2,3,6)-trimethylphenyl, 4-methoxy-(2,3,6)-trimethylphenyl, 4-chloro-2,5-dimethylphenyl, 2-chloro-6-fluoro-3-methylphenyl, 6-chloro-2-fluoro-3-methyl, (2,4,6)-trimethylphenyl and (2,3,4,5,6)-pentafluorophenyl.

In another preferred embodiment, a substituted heteroaryl residue may be selected from the group consisting of 3-methylpyrid-2-yl, 4-methylpyrid-2-yl, 5-methylpyrid-2-yl, 6-methylpyrid-2-yl, 2-methylpyrid-3-yl, 4-methylpyrid-3-yl, 5-methylpyrid-3-yl, 6-methylpyrid-3-yl, 2-methylpyrid-4-yl, 3-methylpyrid-4-yl, 3-fluoropyrid-2-yl, 4-fluoropyrid-2-yl, 5-fluoropyrid-2-yl, 6-fluoropyrid-2-yl, 3-chloropyrid-2-yl, 4-chloropyrid-2-yl, 5-chloropyrid-2-yl, 6-chloropyrid-2-yl, 3-trifluoromethylpyrid-2-yl, 4-trifluoromethylpyrid-2-yl, 5-trifluoromethylpyrid-2-yl, 6-trifluoromethylpyrid-2-yl, 3-methoxypyrid-2-yl, 4-methoxypyrid-2-yl, 5-methoxypyrid-2-yl, 6-methoxypyrid-2-yl, 4-methylthiazol-2-yl, 5-methylthiazol-2-yl, 4-trifluoromethylthiazol-2-yl, 5-trifluoromethylthiazol-2-yl, 4-chlorothiazol-2-yl, 5-chlorothiazol-2-yl, 4-bromothiazol-2-yl, 5-bromothiazol-2-yl, 4-fluorothiazol-2-yl, 5-fluorothiazol-2-yl, 4-cyanothiazol-2-yl, 5-cyanothiazol-2-yl, 4-methoxythiazol-2-yl, 5-methoxythiazol-2-yl, 4-methyloxazol-2-yl, 5-methyloxazol-2-yl, 4-trifluoromethyloxazol-2-yl, 5-trifluoromethyloxazol-2-yl, 4-chlorooxazol-2-yl, 5-chlorooxazol-2-yl, 4-bromooxazol-2-yl, 5-bromooxazol-2-yl, 4-fluorooxazol-2-yl, 5-fluorooxazol-2-yl, 4-cyanooxazol-2-yl, 5-cyanooxazol-2-yl, 4-methoxyoxazol-2-yl, 5-methoxyoxazol-2-yl, 2-methyl-(1,2,4)-thiadiazol-5-yl, 2-trifluoromethyl-(1,2,4)-thiadiazolyl-5-yl, 2-chloro-(1,2,4)-thiadiazol-5-yl, 2-fluoro-(1,2,4)-thiadiazol-5-yl, 2-methoxy-(1,2,4)-thiadiazol-5-yl, 2-cyano-(1,2,4)-thiadiazol-5-yl, 2-methyl-(1,2,4)-oxadiazol-5-yl, 2-trifluoromethyl-(1,2,4)-oxadiazol-5-yl, 2-chloro-(1,2,4)-oxadiazol-5-yl, 2-fluoro-(1,2,4)-oxadiazol-5-yl, 2-methoxy-(1,2,4)-oxadiazol-5-yl and 2-cyano-(1,2,4)-oxadiazol-5-yl.

For the purposes of the presently claimed invention, the term “alkylene” covers acyclic saturated hydrocarbon residues, which may be acyclic saturated hydrocarbon chains, which combine different moieties, as in the case of C₁-C₃₀ alkylene, 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkylene, 1 to 5 (i.e. 1, 2, 3, 4 or 5) C atoms. Representative examples of the alkylene groups include, but are not limited to, —CH₂—CH₂—, —CH₂—CH(CH₃)—, —CH₂—CH(CH₂CH₃)—, —CH₂—CH(n-C₃H₇)—, —CH₂—CH(n-C₄H₉)—, —CH₂—CH(n-C₅H₁₁)—, —CH₂—CH(n-C₆H₁₃)—, —CH₂—CH(n-C₇H₁₅)—, —CH₂—CH(n-C₈H₁₇)—, —CH(CH₃)—CH(CH₃)—, —C(CH₃)₂—, —CH₂—C(CH₃)₂—CH₂—, and —CH₂-[C(CH₃)₂]₂—CH₂—, —(CH₂)₃—, —(CH₂)₄—, —(CH₂)₅—, —(CH₂)₆—, —(CH₂)₈—, —(CH₂)₁₀—, —(CH₂)₇—, —(CH₂)₉—, —(CH₂)₁₁—, —(CH₂)₁₂—, —(CH₂)₁₃—, —(CH₂)₁₄—, —(CH₂)₁₅—, —(CH₂)₁₆—, —(CH₂)₁₇—, —(CH₂)₁₈—, —(CH₂)₁₉—, —(CH₂)₂₀—, —(CH₂)₂₁—, —(CH₂)₂₂—, —(CH₂)₂₃^{—, —(CH}₂)₂₄—, —(CH₂)₂₅—, —(CH₂)₂₆—, —(CH₂)₂₇—, —(CH₂)₂₈—, —(CH₂)₂₉— and —(CH₂)₃₀—.

In another preferred embodiment, the compound of formula (B1) is selected from the group consisting of compounds of formula (B1a) and (B1b),

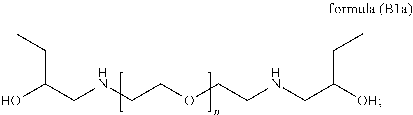

wherein n is an integer in the range of 1 to 1000, more preferably 1 to 500, even more preferably 1 to 100, most preferably 1 to 70 and in particular 1 to 50; and

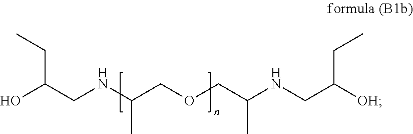

wherein n is an integer in the range of 1 to 1000, more preferably 1 to 500, even more preferably 1 to 100, most preferably 1 to 70 and in particular 1 to 50.

In another preferred embodiment, the compound of formula (B2) is selected from the group consisting of compounds of formula (B2a), (B2b), (B2c), (B2d), (B2e), and (B2f),

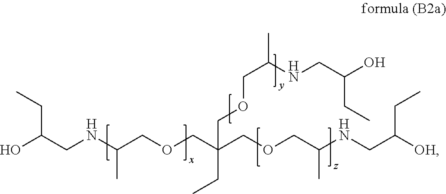

wherein x+y+z is an integer in the range of 1 to 3000, preferably 1 to 1000, more preferably 1 to 500, most preferably 1 to 100 and in particular 1 to 50,

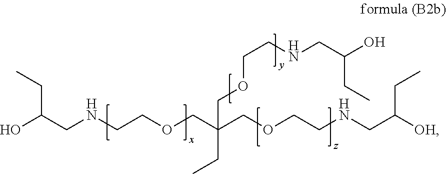

wherein x+y+z is an integer in the range of 1 to 3000, preferably 1 to 1000, more preferably 1 to 500, most preferably 1 to 100 and in particular 1 to 50;

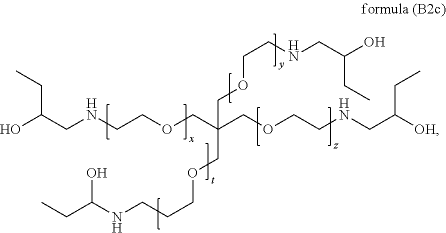

wherein t+x+y+z is an integer in the range of 1 to 3000, preferably 1 to 1000, more preferably 1 to 500, most preferably 1 to 100 and in particular 4 to 50; and the compound of formula (B2d) is

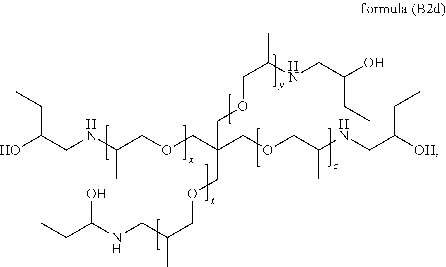

wherein t+x+y+z is an integer in the range of 1 to 3000, preferably 1 to 1000, more preferably 1 to 500, most preferably 1 to 100 and in particular 4 to 50;

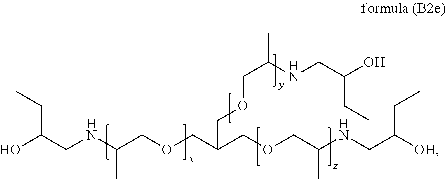

wherein x+y+z is an integer in the range of 1 to 3000, preferably 1 to 1000, more preferably 1 to 500, most preferably 1 to 100 and in particular 1 to 50,

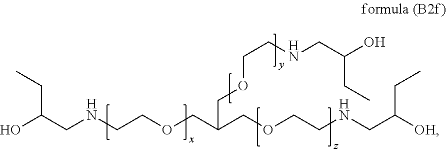

wherein x+y+z is an integer in the range of 1 to 3000, preferably 1 to 1000, more preferably 1 to 500, most preferably 1 to 100 and in particular 1 to 50.

In another preferred embodiment, the compound of formula (B3) is selected from the group consisting of compounds of formula (B3a) and (B3b)

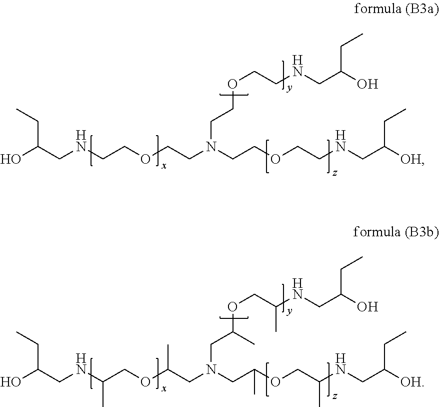

In another preferred embodiment, the polyurea copolymer is obtained by reacting:
a. at least one polyisocyanate (A) which is selected from the group consisting of isophorone diisocyanate, hexamethylene-1,6-diisocyanate, 1,5-pentamethylene diisocyanate, metaphenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates; and
b. at least one isocyanate reactive component (B) which is selected from the group consisting of compounds of formula (B1a), (B1b), (B2a), (B2b), (B2c) and (B2d), wherein B1a), (B1b), (B2a), (B2b), (B2c), (B2d), (B2e), (B2f), (B3a) and (B3b) are as defined as above;
   more preferably the polyurea copolymer is obtained by reacting:
a. at least one polyisocyanate (A) which is selected from the group consisting of isophorone diisocyanate, hexamethylene-1,6-diisocyanate, meta-phenylene diisocyanate, para-phenylene diisocyanate, toluene-2,4-diisocyanate, toluene-2,6-diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates; and
b. at least one isocyanate reactive component (B) which is selected from the group consisting of compounds of formula (B1a), (B1b), (B2a), (B2b), (B2c), (B2d), (B2e), (B2f), (B3a) and (B3b), wherein B1a), (B1b), (B2a), (B2b), (B2c), (B2d), (B2e), (B2f), (B3a) and (B3b) are as defined as above; and
   most preferably the polyurea copolymer is obtained by reacting:
a. at least one polyisocyanate (A) is selected from the group consisting of toluene-2,4-diisocyanate, toluene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2,-methylene -bis(cyclohexyl isocyanate), 3,3′-methylene-bis(cyclohexyl isocyanate), 4,4′-methylene -bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates; and
b. at least one isocyanate reactive component (B) which is selected from the group consisting of compounds of formula (B1a), (B1b), (B2a), (B2b), (B2c), (B2d), (B2e), (B2f), (B3a) and (B3b) wherein B1a), (B1b), (B2a), (B2b), (B2c), (B2d), (B2e), (B2f), (B3a) and (B3b) are as defined as above.

In another preferred embodiment, the polyurea copolymer is obtained by reacting:
a. a polymeric diphenylmethane diisocyanate (A) having NCO functionality of at least ≥2.0; and
b. at least one isocyanate reactive component (B) which is selected from the group consisting of a compound of formula (B1), a compound of formula (B2), a compound of formula (B3) and a compound of formula (B4)

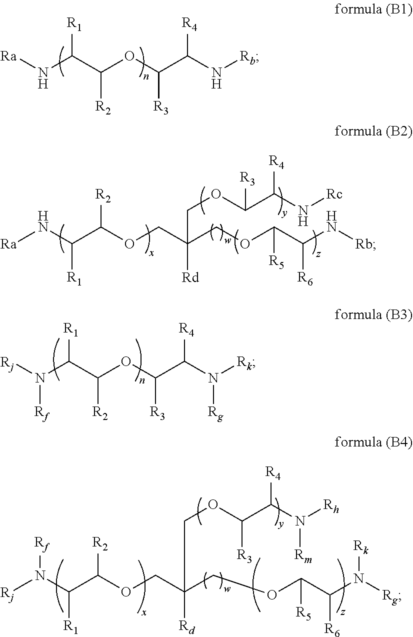

wherein Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 1000;

w is an integer in the range of 0 to 30;

t, x, y and z are independent of each and an integer in the range of 0 to 1000, with the provision that the sum of t+x+y+z is in the range of 1 to 3000

In another preferred embodiment, the polyurea copolymer is obtained by reacting:
a. polymeric diphenylmethane diisocyanate (A) having NCO functionality of at least ≥2.0; and at least one isocyanate reactive component (B) which is selected from the group consisting of compounds of formula (B1a), (B1b), (B2a), (B2b), (B2c) and (B2d), wherein B1a), (B1b), (B2a), (B2b), (B2c) and (B2d) are as defined as above.

In another preferred embodiment, the polyurea copolymer has a weight average molecular weight Mw in the range of 500 g/mol to 5,00,000 g/mol, determined according to the DIN 55672 or in case of high molecular weights where the polymeric material is not soluble in standard organic solvents anymore the molecular weight is determined according to the MALDI-TOF Mass Spectrometry; more preferably the polyurea copolymer has a weight average molecular weight Mw in the range of 1000 g/mol to 2,00,000 g/mol, determined according to the DIN 55672 or in case of high molecular weights where the polymeric material is not soluble in standard organic solvents anymore the molecular weight is determined according to the MALDI-TOF Mass Spectrometry; even more preferably the polyurea copolymer has a weight average molecular weight Mw in the range of 2000 g/mol to 1,00,000 g/mol, determined according to the DIN 55672 or in case of high molecular weights where the polymeric material is not soluble in standard organic solvents anymore the molecular weight is determined according to the MALDI-TOF Mass Spectrometry; most preferably the polyurea copolymer has a weight average molecular weight Mw in the range of 3000 g/mol to 80,000 g/mol, determined according to the DIN 55672 or in case of high molecular weights where the polymeric material is not soluble in standard organic solvents anymore the molecular weight is determined according to the MALDI-TOF Mass Spectrometry; and in particular the polyurea copolymer has a weight average molecular weight Mw in the range of 5000 g/mol to 50,000 g/mol, determined according to the DIN 55672 or in case of high molecular weights where the polymeric material is not soluble in standard organic solvents anymore the molecular weight is determined according to the MALDI-TOF Mass Spectrometry.

In another preferred embodiment, the polyurea copolymer has a weight average molecular weight Mw in the range of 5000 g/mol to 50,000 g/mol, determined according to the DIN 55672 or in case of high molecular weights where the polymeric material is not soluble in standard organic solvents anymore the molecular weight is determined according to the MALDI-TOF Mass Spectrometry.

In another preferred embodiment, the polyurea copolymer has a glass transition temperature in the range of ≥−40° C. to ≤250° C., determined according to ASTM D 3418 at a heating rate of 5 K/min. preferably the polyurea copolymer has a glass transition temperature in the range of ≥−20° C. to ≤250° C., determined according to ASTM D 3418 at a heating rate of 5 K/min; more preferably the polyurea copolymer has a glass transition temperature in the range of ≥0° C. to ≤200° C., determined according to ASTM D 3418 at a heating rate of 5 K/min; even more preferably the polyurea copolymer has a glass transition temperature in the range of ≥20° C. to ≤180° C., determined according to ASTM D 3418 at a heating rate of 5 K/min; most preferably the polyurea copolymer has a glass transition temperature in the range of ≥40° C. to ≤160° C., determined according to ASTM D 3418 at a heating rate of 5 K/min; and in particular the polyurea copolymer has a glass transition temperature in the range of ≥40° C. to ≤150° C., determined according to ASTM D 3418 at a heating rate of 5 K/min

In another preferred embodiment, the process for preparing a polyurea copolymer comprises at least the steps of:
i) providing at least one polyisocyanate (A) which has an average NCO functionality ≥;
ii) providing at least one isocyanate reactive component (B); and
iii) contacting (A) and (B);
   wherein the at least one isocyanate reactive component (B) is a polyetheramine having at least two secondary amine functional groups and at least one hydroxy functional group;
   more preferably the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is a polyetheramine having at least two secondary amine functional groups and at least one hydroxy functional group;
   even more preferably the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is a polyetheramine having at least two secondary amine functional groups and at least one hydroxy functional group;
   most preferably the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is a polyetheramine having at least two secondary amine functional groups and at least one hydroxy functional group.

In another preferred embodiment, the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is selected from the group consisting of a compound of formula (B1), formula (B2), a formula (B3), and a formula (B4),

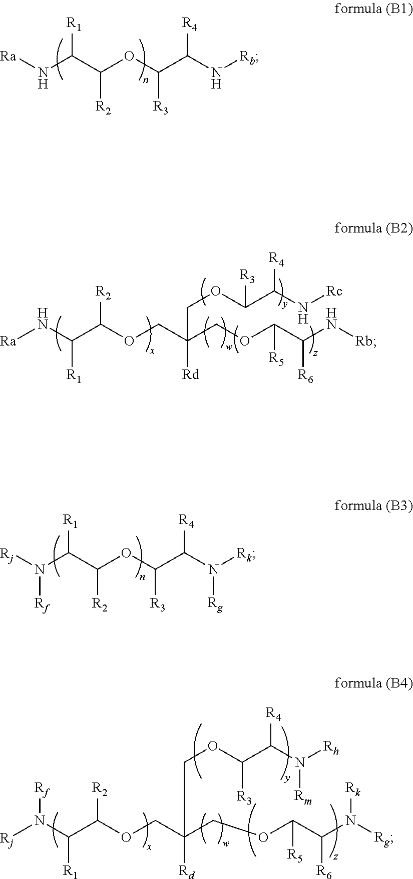

wherein

Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 1000;

w is an integer in the range of 0 to 30;

t, x, y and z are independent of each and an integer in the range of 0 to 1000, with the provision that the sum of t+x+y+z is in the range of 1 to 3000;

more preferably the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is selected from the group consisting of a compound of formula (B1), formula (B2), a formula (B3) and a formula (B4),

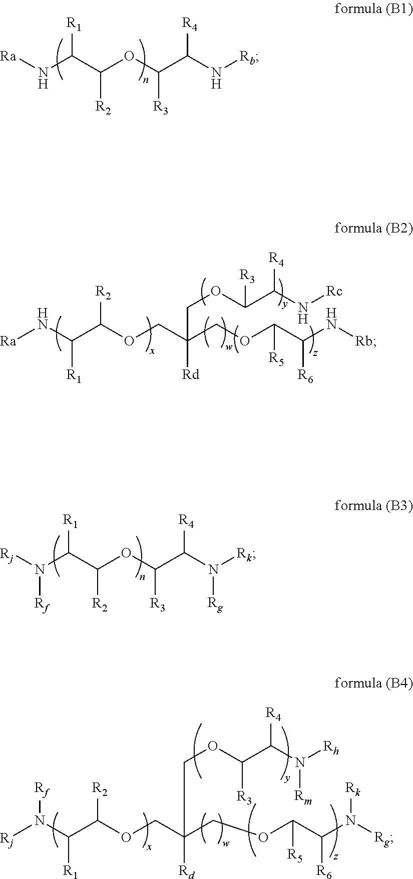

Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))₅—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, and propyl;

n is an integer in the range of 1 to 500;

w is an integer in the range of 0 to 10;

t, x, y and z are independent of each and an integer in the range of 0 to 500, with the provision that the sum of t+x+y+z is in the range of 1 to 1500;

even more preferably the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is selected from the group consisting of a compound of formula (B1), formula (B2), a formula (B3) and a formula (B4),

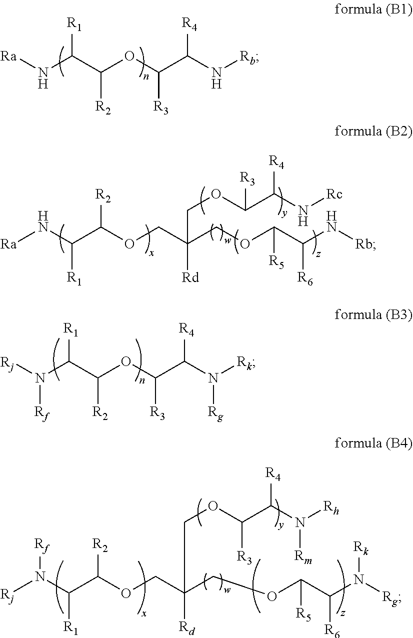

even more preferably Rₐ, R_{b}, R_{c}, R_{g}, Rₘ and Rₑ independently of each other are selected from the group consisting of linear or branched, substituted or unsubstituted C₁-C₂₀ alkyl, linear or branched, substituted or unsubstituted C₂-C₂₀ alkenyl, substituted or unsubstituted, linear or branched 2- to 20-membered heteroalkyl, substituted or unsubstituted C₅-C₂₀ cycloalkyl, substituted or unsubstituted C₆-C₂₀ aryl, substituted or unsubstituted C₁-C₁₀ alkylene C₅-C₁₀ cycloalkyl, substituted or unsubstituted C₁-C₁₀ alkylene 5- to 10-membered heterocycloalkyl, substituted or unsubstituted C₁-C₁₀ alkylene 5- to 20-membered heterocycloalkenyl, substituted or unsubstituted C₁-C₁₀ alkylene C₆-C₂₀ aryl and substituted or unsubstituted C₁-C₁₀ alkylene 5- to 20-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl, substituted or unsubstituted C₁-C₁₀ alkylene C₅-C₃₀ cycloalkyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, and propyl;

n is an integer in the range of 1 to 300;

w is an integer in the range of 0 to 5;

t, x, y and z are independent of each and an integer in the range of 0 to 300, with the provision that the sum of t+x+y+z is in the range of 1 to 900; most preferably the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is selected from the group consisting of a compound of formula (B1), formula (B2), a formula (B3) and a formula (B4),

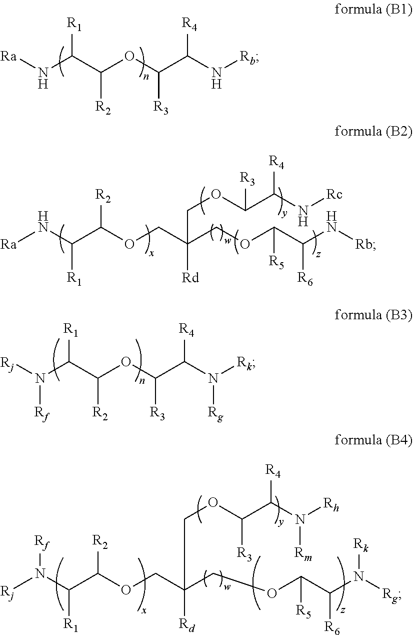

most preferably the Rₐ, R_{b}, R_{c}, R_{g}, Rₘ and Rₑ independently of each other are selected from the group consisting of linear or branched, substituted or unsubstituted C₁-C₁₅ alkyl, linear or branched, substituted or unsubstituted C₂-C₁₅ alkenyl, substituted or unsubstituted C₅-C₁₅ cycloalkyl, substituted or unsubstituted C₆-C₁₀ aryl, substituted or unsubstituted C₁-C₁₀ alkylene C₅-C₁₅ cycloalkyl, and substituted or unsubstituted C₁-C₁₀ alkylene C₆-C₁₅ aryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl and —(CH₂)_{w}—(OCH(R₇)—CH (R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, Rₐ, R₅, R₆, R₇ and R₈ independently of each other are selected from the group consisting of hydrogen, methyl, ethyl, and propyl;

n is an integer in the range of 1 to 100;

w is an integer in the range of 1 to 3;

t, x, y and z are independent of each and an integer in the range of 0 to 100, with the provision that the sum of t+x+y+z is in the range of 1 to 300; and

in particular the process for preparing a polyurea copolymer comprises at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is selected from the group consisting of a compound of formula (B1,) formula (B2) and a formula (B3),

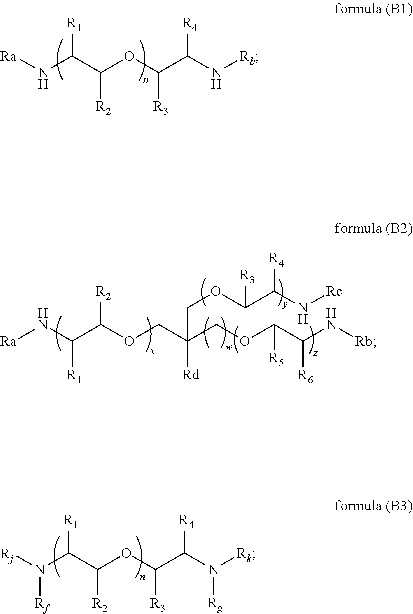

in particular the Rₐ, R_{b}, R_{c}, R_{g}, and Rₑ independently of each other are selected from the group consisting of linear or branched, substituted or unsubstituted C₁-C₁₀ alkyl, substituted or unsubstituted C₅-C₁₀ cycloalkyl, substituted or unsubstituted C₆-C₁₀ aryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl and —(CH₂)_{w}—(OCH(R₇)—CH(R₈))ₜ—NHRₑ;

R_{g} and Rₖ independently of each other are selected from the group consisting of hydrogen and — (CH₂)_{w}—(OCH(R₇)—CH(R₈))ₜ—NHRₑ;

Rⱼ and R_{f} are —(CH₂)_{w}—(OCH(R₇)—CH(R₈))ₜNHRₑ;

R₁, R₂, R₃, R₄, R₅, R₆, R₇ and R₈ independently of each other are selected from the group consisting of hydrogen, and methyl;

n is an integer in the range of 1 to 100;

w is an integer in the range of 1 to 3;

t, x, y and z are independent of each and an integer in the range of 0 to 50, with the provision that the sum of t+x+y+z is in the range of 1 to 150.

In another preferred embodiment, the molar ratio of NCO in the at least one polyisocyanate (A) to —NH— in the isocyanate reactive component (B) is in the range of ≥1.0:10 to ≤10:1.0; more preferably the molar ratio of NCO in the at least one polyisocyanate (A) to —NH— in the isocyanate reactive component (B) is in the range of ≥1.0:6 to ≤6:1.0; even more preferably the molar ratio of NCO in the at least one polyisocyanate (A) to —NH— in the isocyanate reactive component (B) is in the range of ≥1.0:5 to ≤5:1.0; most preferably the molar ratio of NCO in the at least one polyisocyanate (A) to —NH— in the isocyanate reactive component (B) is in the range of ≥1.0:3 to ≤3:1.0; and in particular the molar ratio of NCO in the at least one polyisocyanate (A) to —NH— in the isocyanate reactive component (B) is in the range of ≥1.0:2.0 to ≤2.0:1.0.

In another preferred embodiment, the molar ratio of NCO in the at least one polyisocyanate (A) to —NH— in the isocyanate reactive component (B) is in the range of ≥1.0:0.5 to ≤0.5:1.0.

In another preferred embodiment, in the process for preparing a polyurea copolymer the step iii) is carried out at a temperature in the range of ≥−50° C. to ≤250° C.; more preferably the step iii) is carried out at a temperature in the range of ≥−30° C. to ≤200° C.; even more preferably the step iii) is carried out at a temperature in the range of ≥−4° C. to ≤160° C.; most preferably the step iii) is carried out at a temperature in the range of ≥0° C. to ≤160° C.; and in particular the step iii) is carried out at a temperature in the range of ≥20° C. to ≤140° C.

In another preferred embodiment, the process for preparing a polyurea copolymer is carried out in the presence of at least one solvent.

In another preferred embodiment, the at least one solvent is selected from the group consisting of the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone.

In another preferred embodiment, the presently claimed invention is directed to an article comprising a polyurea copolymer as described herein.

In another preferred embodiment, the presently claimed invention is directed to a process for reshaping a polyurea copolymer comprising at least the steps of:
a) applying pressure and heat to the polyurea copolymer as described herein to obtain a heated polyurea copolymer; and
b) reshaping the polyurea copolymer of step a).

In another preferred embodiment, reshaping the polyurea copolymer is performed at a pressure in the range of ≥5×10³ Pa to ≤10⁷ Pa.

In another preferred embodiment, reshaping the polyurea copolymer is performed at a temperature in the range of ≥60° C. to ≤300° C.

The presently claimed invention is associated with at least one of the following advantages:
(i) A new class of polyurea copolymer has been developed with dynamic bonds.
(ii) A new class of polyurea copolymer has been developed with recyclability.
(iii) A new of polyurea copolymer has been developed with a three-dimensional network structure based on reacting polyisocyanates and polyamines only without the use of additional cross linker.

### Embodiments

1. A polyurea copolymer obtained by reacting:
a. at least one polyisocyanate (A); and
b. at least one isocyanate reactive component (B);
   wherein the at least one polyisocyanate (A) has an NCO functionality of at least ≥2.0; and
   the at least one isocyanate reactive component (B) is selected from the group consisting of a compound of formula (B1), formula (B2), a formula (B3) and a formula (B4),

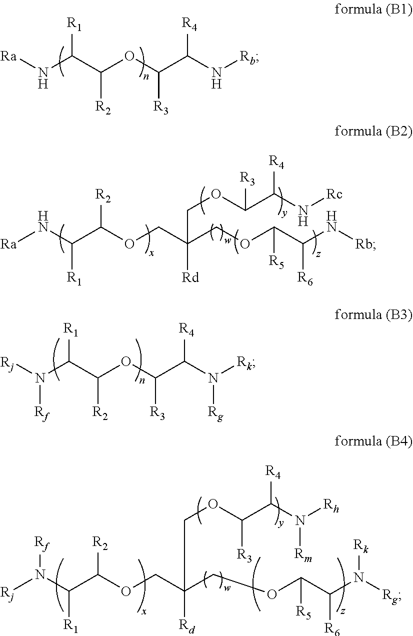

wherein

Rₐ, R_{b}, R_{c}, R_{g}, Rₘ and Rₑ independently of each other are selected from the group consisting of linear or branched, substituted or unsubstituted C₁-C₃₀ alklyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, Rₐ, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 1000;

w is an integer in the range of 0 to 30;

t, x, y and z are independent of each and an integer in the range of 0 to 1000, with the provision that the sum of t+x+y+z is in the range of 1 to 3000.

2. The polyurea copolymer according to embodiment 1, wherein the at least one polyisocyanate (A) has an average NCO functionality in the range of 2.0 to 6.0.

3. The polyurea copolymer according to embodiment 1, wherein the at least one polyisocyanate (A) is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(para-isocyano -cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato -cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy -biphenylene diisocyanate, 2,4-bis(b-isocyanato-t-butyl)toluene, bis(para-b-isocyanato-t-butyl -phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCH(CH₂)₃N(CH₃)(CH₂)₃NCO, triphenylmethane-4,4′,4″-triisocyanate, toluene-2,4,6-triyl triisocyanate, ethyl ester l-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene)isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates.

4. The polyurea copolymer according to any one of embodiments 1 to 3, wherein the at least one polyisocyanate (A) is present in the form of dimer, trimer and oligomers containing a urethane group, an isocyanurate group, a biuret group, an uretdione group, an allophanate group and/or an iminooxadiazinedione group.

5. The polyurea copolymer according to any one of embodiments 1 to 4, wherein the at least one polyisocyanate (A) is selected from the group consisting of isophorone diisocyanate, hexamethylene-1,6-diisocyanate, 1,5-pentamethylene diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates.

6. The polyurea copolymer according to any one of the embodiment 1, wherein Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted C₅-C₂₀ cycloalkyl, substituted or unsubstituted C₅-C₂₀ cycloalkenyl, substituted or unsubstituted aryl and substituted or unsubstituted aralkyl; each case substituted with at least one hydroxy functional group;

R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₂₀ cycloalkyl, substituted or unsubstituted C₅-C₂₀ cycloalkenyl, substituted or unsubstituted aryl, substituted or unsubstituted aralkyl and —(CH₂)_{w}—(OCH(R₇)—CH(R₈))ₜ—NHRₑ;

R_{f}, Rₕ, Rⱼ and Rₖ independently of each other are selected from the group consisting of hydrogen and —(CH₂)_{w}—(OCH(R₇)—CH(R₈))ₜ—NHRₑ;

R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;

n is an integer in the range of 1 to 300;

w is an integer in the range of 0 to 30;

t, x, y and z are independent of each and an integer in the range of 0 to 300, with the provision that the sum of t+x+y+z is in the range of 1 to 900.

7. The polyurea copolymer according to any one of embodiments 1 to 6, wherein the compound of formula (B1) is selected from the group consisting of compounds of formula (B1a) and (B1b),

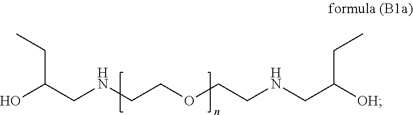

wherein n is an integer in the range of 1 to 1000; and

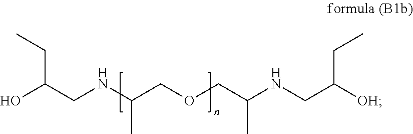

wherein n is an integer in the range of 1 to 1000.

8. The polyurea copolymer according to any one of embodiments 1 to 6, wherein the compound of formula (B2) is selected from the group consisting of compounds of formula (B2a), (B2b), (B2c), (B2d), (B2e) and (B2f),

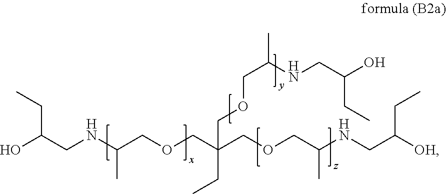

wherein x+y+z is an integer in the range of 1 to 3000,

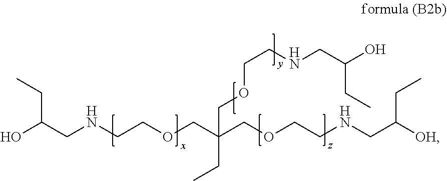

wherein x+y+z is an integer in the range of 1 to 3000;

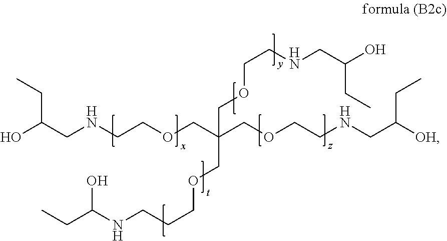

wherein t+x+y+z is an integer in the range of 1 to 3000; and

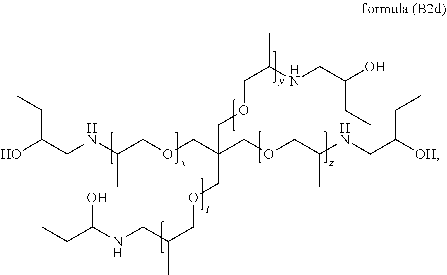

wherein t+x+y+z is an integer in the range of 1 to 3000;

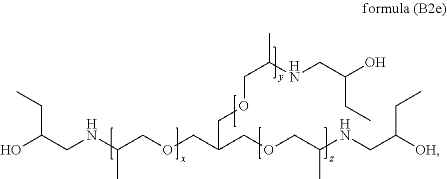

wherein x+y+z is an integer in the range of 1 to 3000;

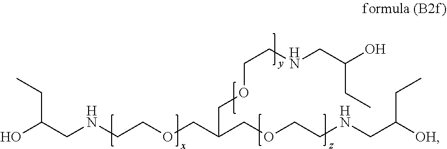

wherein x+y+z is an integer in the range of 1 to 3000.

9. The polyurea copolymer according to any one of claims 1 to 6, wherein the compound of formula (B3) is selected from the group consisting of compounds of formula (B3a) and (B3b),

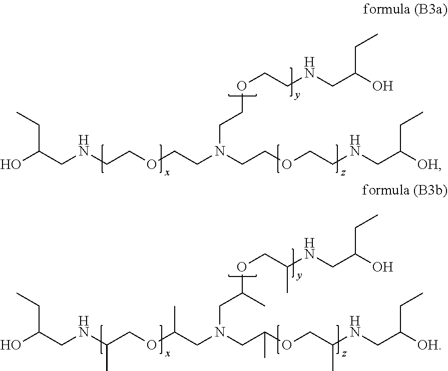

10. The polyurea copolymer according to any one of embodiments 1 to 9, wherein
a. at least one polyisocyanate (A) is selected from the group consisting of isophorone diisocyanate, hexamethylene-1,6-diisocyanate, 1,5-pentamethylene diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates; and
b. at least one isocyanate reactive component (B) is selected from the group consisting of compounds of formula (B1a), (B1b), (B2a), (B2b), (B2c), (B2d), (B2e), (B2f), (B3a) and (B3b), wherein compounds of formula compounds of formula (B1a), (B1b), (B2a), (B2b), (B2c), (B2d), (B2e), (B2f), (B3a) and (B3b) as defined as in embodiments 7 to 9.

11. The polyurea copolymer according to any one of embodiments 1 to 10, wherein the polyurea copolymer has a weight average molecular weight Mw in the range of 500 g/mol to 5,00,000 g/mol determined according to the DIN 55672 or in case of high molecular weights where the polymeric material is not soluble in standard organic solvents anymore the molecular weight is determined according to the MALDI-TOF Mass Spectrometry.

12. The polyurea copolymer according to embodiment 12, wherein the polyurea copolymer has a weight average molecular weight Mw in the range of 5000 g/mol to 50,000 g/mol determined according to the method as described in the description or in case of high molecular weights where the polymeric material is not soluble in standard organic solvents anymore the molecular weight is determined according to the MALDI-TOF Mass Spectrometry.

13. The polyurea copolymer according to any one of embodiments 1 to 12, wherein the polyurea copolymer has a glass transition temperature in the range of ≥−40° C. to ≤250° C., determined according to ASTM D 3418 at a heating rate of 5 K/min.

14. A process for preparing a polyurea copolymer according to any one of embodiments 1 to 13 comprising at least the steps of:
i) providing at least one polyisocyanate (A) which has an average NCO functionality ≥2.0;
ii) providing at least one isocyanate reactive component (B); and
iii) contacting (A) and (B);
   wherein the at least one isocyanate reactive component (B) is a polyetheramine having at least two secondary amine functional groups and at least one hydroxy functional group.

15. The process according to embodiment 14, wherein the molar ratio of NCO in the at least one polyisocyanate (A) to —NH— in the isocyanate reactive component (B) is in the range of ≥1.0:10 to ≤10:1.0.

16. The process according to embodiment 15, wherein the molar ratio of NCO in the at least one polyisocyanate (A) to —NH— in the isocyanate reactive component (B) is in the range of ≥1.0:2.0 to ≤2.0:1.0.

17. The process according to embodiment 16, wherein the molar ratio of NCO in the at least one polyisocyanate (A) to —NH— in the isocyanate reactive component (B) is in the range of ≥1.0:0.5 to ≤0.5:1.0.

18. The process according to any one of embodiments 14 to 17, wherein step iii) carried out at a temperature in the range of ≥−50° C. to ≤250° C.

19. The process according to any one of embodiments 14 to 18, wherein the reaction is carried out in the presence of at least one solvent.

20. The process according to embodiment 19, wherein the at least one solvent is selected from the group consisting of the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone.

21. An article comprising a polyurea copolymer according to any one of embodiments 1 to 13 or a polyurea copolymer obtained according any one of embodiments 14 to 20.

22. A process for reshaping a polyurea copolymer according to any one of embodiments 1 to 13 or a polyurea copolymer obtained according any one of embodiments 14 to 20 or an article according to embodiment 21 comprising at least the steps of:
a) applying pressure and heat to the polyurea copolymer to obtain a heated polyurea copolymer; and
b) reshaping the polyurea copolymer of step a).

23. The process according to embodiment 22, wherein the pressure is the range of ≥5×10³ Pa to ≤10⁷ Pa.

24. The process according to embodiment 23, wherein the temperature is the range of ≥60° C. to ≤300° C.

While the presently claimed invention has been described in terms of its specific embodiments, certain modifications and equivalents will be apparent to those skilled in the art and are intended to be included within the scope of the presently claimed invention

### EXAMPLES

### Materials

PMDI (Lupranat M20 FB) was obtained from BASF. TDI T80 (80% 2,4-TDI, 20% 2,6-TDI) was obtained from BASF SE. TDI T100 (100% 2,4-TDI) was obtained from Sigma-Aldrich. D400 (Baxxodur® EC302), T403 (Baxxodur® EC310), D2000 (Baxxodur® EC303) and T5000 were all obtained from BASF SE. These polyetheramines were alkoxylated according to the procedures given below. THF was dried using molecular sieves (4 A).

| PMDI | Polymeric diphenylmethane diisocyanate |
|---|---|
| BuO-D400 | 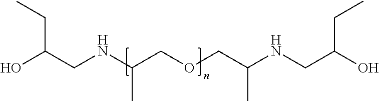 |
| | n ≈ 6.1 |
| BuO-T403 | 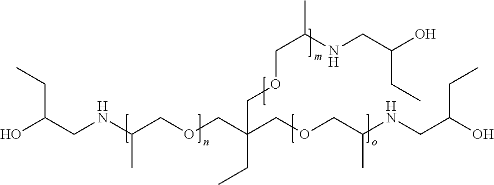 |
| | n + m + o ≈ 5.5 |
| BuO-D2000 | 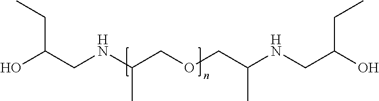 |
| | n ≈ 33 |
| BuO-T5000 | 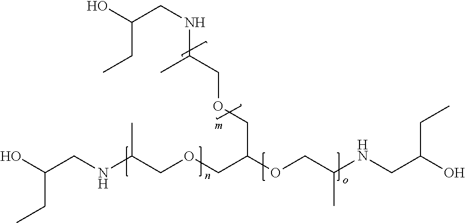 |
| | n + m + o ≈ 85 |

### Methods

DSC was used to determine the reaction enthalpy and the glass transition temperature according to ASTM D 3418 using a heating rate of 5 K/min.

Residual NCO content was determined by IR spectroscopy.

TGA spectra were obtained according to ISO 11358 under N₂ atmosphere in gold crucibles.

Method for Thermal Reshaping

### Test Method:

The polymer powder/granulate obtained according to the examples was transferred to a hot press. When applying 20 kN of pressure and 160-180° C. for at least 5 minutes, the polymer powder was reshaped to a solid, cookie-shaped plate.

The polymer powder obtained according to presently claimed invention was reshaped in cookies/plate, however, the cookies/plates formed from the polymer obtained according to comparative examples was not solid and falls apart easily.

### Synthesis

Synthesis of the Secondary Polyetheramines:
a) Polyetheramine D400 (=Baxxodur EC 302)+0.5 BuO/NH:

Polyetheramine D400 (2600 g) was mixed with water (260 g) and filled into a 5 L steel reactor. After inertization of the reactor using nitrogen, a nitrogen pre-pressure of 2 bar is applied. The mixture was heated to 120° C. and butylene oxide (50 g) was added to the reactor. Another lot of butylene oxide (887 g) was dosed into the reactor over a period of 12 hours. After completion of the reaction the product was isolated (3501 g).

### Analytics:

OH-value (phthalic anhydride method, ISO 6796): 312 mg KOH/g

Amino value: 183 mg KOH/g
b) Polyetheramin D2000 (=Baxxodur EC 303)+0.5 BuO/NH:

Polyetheramine D2000 (3000 g) was mixed with water (300 g) and filled into a 5 L steel reactor. After inertization of the reactor using nitrogen, a nitrogen pre-pressure of 2 bar is applied. The mixture was heated to 100° C. and butylene oxide (50 g) was added to the reactor. Another lot of butylene oxide (169 g) was dosed into the reactor over a period of 12 hours. After completion of the reaction the product was isolated (3210 g).

### Analytics:

OH-value (acetic anhydride method, ASTM E222): 86 mg KOH/g

Amino value: 53 mg KOH/g
c) Polyetheramin T5000 (=Baxxodur EC 311)+0.5 BuO/NH:

Polyetheramine T5000 (2068 g) was mixed with water (207 g) and filled into a 5 L steel reactor. After inertization of the reactor using nitrogen, a nitrogen pre-pressure of 2 bar is applied. The mixture was heated to 100° C. and butylene oxide (50 g) was added to the reactor. Another lot of butylene oxide (40 g) was dosed into the reactor over a period of 12 hours. After completion of the reaction the product was isolated (2138 g).

### Analytics:

OH-value (acetic anhydride method, ASTM E222): 76 mg KOH/g

Amino value: 28 mg KOH/g
d) Polyetheramin T403 (=Baxxodur EC 310)+0.5 BuO/NH:

Polyetheramine T403 (2893 g) was mixed with water (289 g) and filled into a 5 L steel reactor. After inertization of the reactor using nitrogen, a nitrogen pre-pressure of 2 bar is applied. The mixture was heated to 120° C. and butylene oxide (50 g) was added to the reactor. Another lot of butylene oxide (599 g) was dosed into the reactor over a period of 12 hours. After completion of the reaction the product was isolated (3508 g).

### Analytics:

OH-value (phthalic anhydride method, ISO 6796): 453 mg KOH/g

Amino value: 285 mg KOH/g

### Example 1

Polymeric methylene diphenylisocyanate (pMDI) (16.52 g, f=2.53) and anhydrous THF (250 g) were charged in a flask under N2 atmosphere and cooled using an ice bath. Compound “a)” (Polyetheramin D400+0.5 BuO/NH) (16.65 g) in anhydrous THF (50 g) was slowly added to form polyurea. After stirring for 1 hour, the reaction mixture was warmed to room temperature. Stirring was continued until polymerization was complete, which was confirmed by disappearance of the NCO band in IR. THF was evaporated under reduced pressure. The resulting material was crushed and dried under reduced pressure to remove residual traces of THF. The product was obtained as a slightly yellowish solid in quantitative yield.

### Example 5

Toluene-2,4-diisocyanate (TDI T100) (3.00 g, 17 mmol) and anhydrous THF (150 g) were charged in a flask under N₂ atmosphere. Compound “d)” (Polyetheramine T403+0.5 BuO/NH) (7.08 g) in anhydrous THF (25 g) was added slowly to form polyurea. The reaction mixture was stirred until polymerization was complete, which was confirmed by disappearance of the NCO band in IR. THF was evaporated under reduced pressure (70° C.). The resulting material was crushed and dried under reduced pressure to remove residual traces of THF. The product was obtained as a clear solid in quantitative yield.

TABLE 1
The isocyanate used is PMDI

| | | Ratio | Ratio | | TGA 5% | Thermal Reshaping |
|---|---|---|---|---|---|---|
| Exp. | Amine | PMDI: | NCO: | E- | mass loss | [Conditions: 20 kN, |
| No. | used | Amine | amine | Modulus | [° C.] | 180° C., 5 min] |
| 1 | D400-BuO | 0.80:1.0 | 1.0:1.0 | | 237 | Yes |
| 2 | T403-BuO | 0.80:1.0 | 1.0:1.0 | 170 MPa | 223 | Yes |
| 3 | D2000-BuO | 0.80:1.0 | 1.0:1.0 | | >300 | Yes |
| 4 | T5000-BuO | 0.80:1.0 | 1.0:1.0 | | >300 | Yes |

TABLE 2
The isocyanate used is TDI

| | | | | | | Thermal |
|---|---|---|---|---|---|---|
| | | | | | | reshaping |
| | | | Ratio | | TGA 5% | [Conditions: 20 |
| | Amine | | NCO: | | mass loss | kN, 180° C., |
| Exp. No. | used | Type of TDI | amine | E-Modulus | [° C.] | 5 min] |
| 5 | T403-BuO | T100 (pure | 1.0:1.0 | 1.5 GPa | 204 | Yes |
| | | Toluene-2,4- | | | | |
| | | diisocyanate) | | | | |
| 6 | T403-BuO | T80 | 1.0:1.0 | | 230 | Yes |
| | | (80% | | | | |
| | | Toluene-2,4- | | | | |
| | | diisocyanate, | | | | |
| | | 20% | | | | |
| | | Toluene-2,6- | | | | |
| | | diisocyanate) | | | | |

Thermosets are the material of choice for many applications due to their stability, mechanical properties, and chemical resistance—properties that result from the permanently cross-linked molecular network they consist of. In contrast to thermoplastics though, thermosets cannot be thermally reshaped and therefore not easily recycled.

The presently invention provides a new class of polyurea copolymer which can be recycled. It is evident from above examples that the use of polymeric diisocyanates lead to formation of recyclable polyurea copolymer having 3-dimensional network structure with dynamic urea bonds. This introduction of exchangeable chemical bonds is an attractive chemical strategy to combine the stability of thermosets with the processability of thermoplastics.

1.-24. (canceled)

25. A polyurea copolymer obtained by reacting:
a. at least one polyisocyanate (A); and
b. at least one isocyanate reactive component (B);
wherein the at least one polyisocyanate (A) has an NCO functionality of at least ≥2.0; and the at least one isocyanate reactive component (B) is selected from the group consisting of a compound of formula (B1), formula (B2), a formula (B3) and a formula (B4), 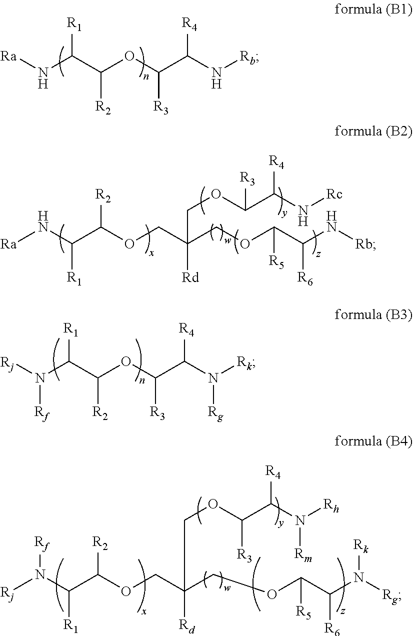
wherein
Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl; each case substituted with at least one hydroxy functional group;
R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl, substituted or unsubstituted C₁-C₁₀ alkylene 5- to 30-membered heteroaryl and —(CH₂)_{w}—(OCH(R₇)—CH(R₈))ₜ—NHRₑ;
R_{f}, Rₕ, Rⱼ and Rₖ independently of each other are selected from the group consisting of hydrogen and —(CH₂)_{w}—(OCH(R₇)—CH(R₈))ₜ—NHRₑ;
R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;
n is an integer in the range of 1 to 1000;
w is an integer in the range of 0 to 30;
t, x, y and z are independent of each and an integer in the range of 0 to 1000, with the provision that the sum of t+x+y+z is in the range of 1 to 3000.

26. The polyurea copolymer according to claim 25, wherein the at least one polyisocyanate (A) has an average NCO functionality in the range of ≥2.0 to ≤6.0.

27. The polyurea copolymer according to claim 25, wherein the at least one polyisocyanate (A) is selected from the group consisting of isophorone diisocyanate, propylene-1,2-diisocyanate, propylene-1,3 -diisocyanate, butylene-1,2-diisocyanate, butylene-1,3 -diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenyl sulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(para-isocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato -cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2,4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCH(CH₂)₃N(CH₃)(CH₂)₃NCO, triphenylmethane-4,4′,4″-triisocyanate, toluene-2,4,6-triyl triisocyanate, ethyl ester l-lysine triisocyanate, 1,6,11-triisocyanatoundecane, 2,2-bis[[4-(isocyanatomethyl)phenyl]methyl]butyl n-[[4-(isocyanatomethyl)phenyl]methyl] carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates.

28. The polyurea copolymer according to claim 25, wherein the at least one polyisocyanate (A) is present in the form of dimer, trimer and oligomers containing a urethane group, an isocyanurate group, a biuret group, an uretdione group, an allophanate group and/or an iminooxadiazinedione group.

29. The polyurea copolymer according to claim 25, wherein the at least one polyisocyanate (A) is selected from the group consisting of isophorone diisocyanate, hexamethylene-1,6-diisocyanate, 1,5-pentamethylene diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2, -methylene-bis(cyclohexyl isocyanate), 3,3′-methylene-bis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates.

30. The polyurea copolymer according to claim 25, wherein Rₐ, R_{b}, R_{c}, R_{g}, Rₘ and Rₑ independently of each other are selected from the group consisting of linear or branched, substituted or unsubstituted C₁-C₃₀ alkyl, linear or branched, substituted or unsubstituted C₂-C₃₀alkenyl, substituted or unsubstituted C₅-C₂₀ cycloalkyl, substituted or unsubstituted C₅-C₂₀ cycloalkenyl, substituted or unsubstituted aryl and substituted or unsubstituted aralkyl; each case substituted with at least one hydroxy functional group;
R_{d} is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₂₀ cycloalkyl, substituted or unsubstituted C₅-C₂₀ cycloalkenyl, substituted or unsubstituted aryl, substituted or unsubstituted aralkyl and —(CH₂)_{w}—(OCH(R₇)—CH(R₈))ₜ—NHRₑ;
R_{f}, Rₕ, Rⱼ and Rₖ independently of each other are selected from the group consisting of hydrogen and —(CH₂)_{w}—(OCH(R₇)—CH(R₈))ₜ—NHRₑ;
R₁, R₂, R₃, R₄, R₅, R₆, R₇ and R₈ independently of each other are selected from the group consisting of hydrogen, methyl, ethyl, propyl, isopropyl, n-butyl, isobutyl and tert-butyl;
n is an integer in the range of 1 to 300;
w is an integer in the range of 0 to 30;
t, x, y and z are independent of each and an integer in the range of 0 to 300, with the provision that the sum of t+x+y+z is in the range of 1 to 900.

31. The polyurea copolymer according to claim 25, wherein the compound of formula (B1) is selected from the group consisting of compounds of formula (B1a) and (B1b), 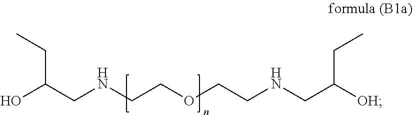
wherein n is an integer in the range of 1 to 1000; and 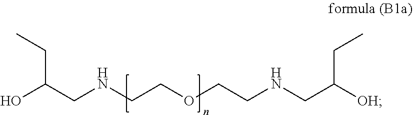
wherein n is an integer in the range of 1 to 1000.

32. The polyurea copolymer according to claim 25, wherein the compound of formula (B2) is selected from the group consisting of compounds of formula (B2a), (B2b), (B2c), (B2d), (B2e) and (B2f), 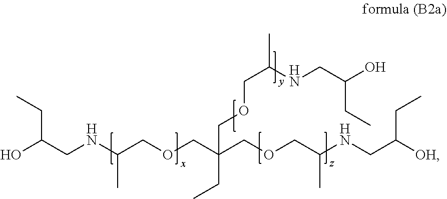
wherein x+y+z is an integer in the range of 1 to 3000, 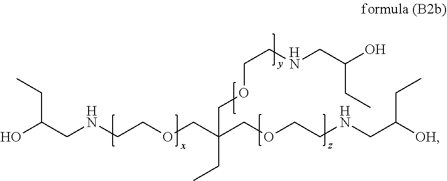
wherein x+y+z is an integer in the range of 1 to 3000; 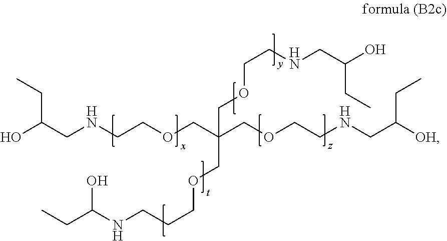
wherein t+x+y+z is an integer in the range of 1 to 3000; and 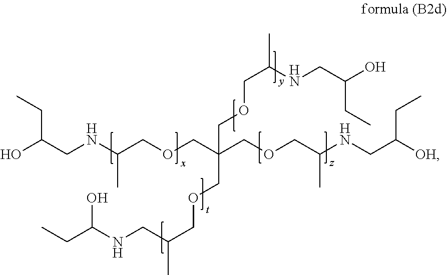
wherein t+x+y+z is an integer in the range of 1 to 3000; 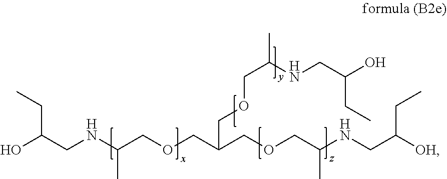
wherein x+y+z is an integer in the range of 1 to 3000; 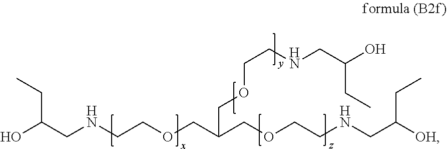
wherein x+y+z is an integer in the range of 1 to 3000.

33. The polyurea copolymer according to claim 25, wherein the compound of formula (B3) is selected from the group consisting of compounds of formula (B3a) and (B3b),

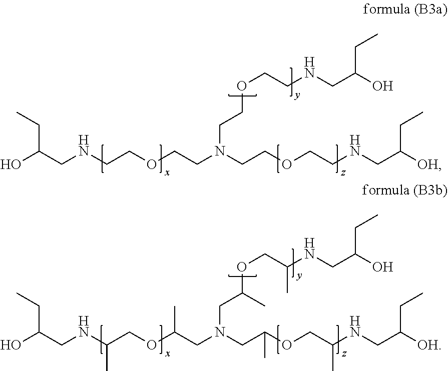

34. The polyurea copolymer according to claim 25, wherein
a. at least one polyisocyanate (A) is selected from the group consisting of isophorone diisocyanate, hexamethylene-1,6-diisocyanate, 1,5-pentamethylene diisocyanate, metaphenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2,-methylene -bis(cyclohexyl isocyanate), 3,3′-methylene-bis(cyclohexyl isocyanate), 4,4′-methylene -bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates; and
b. at least one isocyanate reactive component (B) is selected from the group consisting of compounds of formula (B1a), (B1b), (B2a), (B2b), (B2c), (B2d), (B2e), (B2f), (B3a) and (B3b),
wherein compounds of formula compounds of formula (B1a), (B1b), (B2a), (B2b), (B2c), (B2d), (B2e), (B2f), (B3a) and (B3b) as defined as claim 31.

35. The polyurea copolymer according to claim 25, wherein the polyurea copolymer has a weight average molecular weight Mw in the range of 500 g/mol to 5,00,000 g/mol determined according to the DIN 55672 or in case of high molecular weights where the polymeric material is not soluble in standard organic solvents anymore the molecular weight is determined according to the MALDI-TOF Mass Spectrometry.

36. The polyurea copolymer according to claim 35, wherein the polyurea copolymer has a weight average molecular weight Mw in the range of 5000 g/mol to 50,000 g/mol determined according to the method as described in the description.

37. The polyurea copolymer according to claim 25, wherein the polyurea copolymer has a glass transition temperature in the range of ≥−40° C. to ≤250° C., determined according to ASTM D 3418 at a heating rate of 5 K/min.

38. A process for preparing a polyurea copolymer according to claim 25 comprising at least the steps of:
iv) providing at least one polyisocyanate (A) which has an average NCO functionality ≥2.0;
v) providing at least one isocyanate reactive component (B); and
vi) contacting (A) and (B);
wherein the at least one isocyanate reactive component (B) is a polyetheramine having at least two secondary amine functional groups and at least one hydroxy functional group.

39. The process according to claim 38, wherein the molar ratio of NCO in the at least one polyisocyanate (A) to —NH— in the isocyanate reactive component (B) is in the range of ≥1.0:10 to ≤10:1.0.

40. The process according to claim 39, wherein the molar ratio of NCO in the at least one polyisocyanate (A) to —NH— in the isocyanate reactive component (B) is in the range of ≥1.0:2.0 to ≤2.0:1.0.

41. The process according to claim 40, wherein the molar ratio of NCO in the at least one polyisocyanate (A) to —NH— in the isocyanate reactive component (B) is in the range of ≥1.0:0.5 to ≤0.5:1.0.

42. The process according to claim 38, wherein step iii) carried out at a temperature in the range of ≥−50° C. to ≤250° C.

43. The process according to claim 38, wherein the reaction is carried out in the presence of at least one solvent.

44. The process according to claim 43, wherein the at least one solvent is selected from the group consisting of the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone.

45. An article comprising a polyurea copolymer according to claim 25 or a polyurea copolymer obtained according claim 38.

46. A process for reshaping a polyurea copolymer according to claim 25 or a polyurea copolymer obtained according claim 38 or an article according to claim 45 comprising at least the steps of:
c) applying pressure and heat to the polyurea copolymer to obtain a heated polyurea copolymer; and
d) reshaping the polyurea copolymer of step a).

47. The process according to claim 46, wherein the pressure is the range of ≥5×10³ Pa to ≤10⁷ Pa.

48. The process according to claim 47, wherein the temperature is the range of ≥60° C. to ≤300° C.
